(19) United States
(12) Patent Application Publication
(10) Pub. No.: US 2019/0263281 A1
(43) Pub. Date: Aug. 29, 2019

(54) DOCKING STATION FOR MOTORISED VEHICLES

(71) Applicant: NEURON MOBILITY PTE LTD., Singapore (SG)

(72) Inventor: Zizi WANG, Singapore (SG)

(73) Assignee: Neuron Mobility Pte Ltd., Singapore (SG)

(21) Appl. No.: 16/309,873

(22) PCT Filed: May 24, 2017
(86) PCT No.: PCT/SG2017/050268

§ 371 Date: Dec. 13, 2018

(30) Foreign Application Priority Data
Jun. 16, 2016 (SG) 10201604920Y
Jan. 20, 2017 (SG) 10201700513U
Feb. 21, 2017 (SG) 10201701350Y

(51) Int. Cl. B60L 53/31; B60L 53/80; B60L 53/60; B60L 53/30; B62H 5/00; B60S 5/06; B60L 53/16

(52) U.S. Cl. CPC B60L 53/31; B60L 53/80; B60L 53/60; B60L 2200/24; B62H 5/00; B60S 5/06; B60L 53/16; B60L 53/305

(57) ABSTRACT

A docking station comprises a connector for releasably connecting a motorised vehicle; and a charging unit that is joined to the connector for supplying resource to the motorised vehicle through the connector. Optionally, the docking station comprises a holder for receiving a scooter; and a hub connector for connecting the scooter. The holder preferably comprises a lock for fastening the scooter, whilst the lock is preferably configured to detachably receive or release the scooter.

The present application claims a first priority date of Singapore patent application Number (SG)10201604920Y that was filed on 16 Jun. 2016, which has a title of Short Distance Mobility Sharing System.

The present application also claims a second priority date of Singapore patent application Number (SG)10201700513U that was filed on 20 Jan. 2017, which has a title of Docking Station for a Transport System.

The present application further claims a third priority date of Singapore patent application Number (SG)10201701350Y that was filed on 21 Feb. 2017, which has a title of Motorised Scooter.

All subject matter or content of these above-mentioned three priority applications is hereby incorporated by reference.

The present application relates to a docking station for motorised vehicles. The application also relates method for manufacturing, assembling, using, installing, repairing, configuring, upgrading, monitoring, dismantling, recycling or integrating the docking station.

In cities, typical short distance trips range from one kilometre to two kilometres. Sometimes, shorter trips are about six hundred to eight hundred metres. People often take these short distance trips for travelling from their residences to stations of public transport systems (e.g. rapid transit, metro systems or Mass Rapid Transit). Workers usually take additional short distance trips to reach their workplace, after disembarking from the stations of the public transport systems. At present, walking is a primary mode of transport when taking these short distance trips. Although bicycles and personal transporters (e.g. Segway Personal Transporter) are available for making the short distance trips faster, the bicycles and personal transporters are normally cumbersome to be carried along when taking the public transport systems, thus preventing the bicycle and personal transporters to be used in cooperation with the public transport systems. Hence, viable solutions of the short distance trips are desired.

The present inventions aim to provide one or more new and useful docking stations for motorised vehicles, automobiles or electric vehicles. The motorised vehicle has many types that includes electric scooters (i.e. e-scooters), motor electric scooters, motorized wheelchairs, mobility electric scooters, electric kick scooters, self-balancing electric scooters (i.e. self-balancing two-wheeled boards or hover-boards), self-balancing unicycles, automated guided vehicle or automatic guided vehicle (AGV) and unmanned aerial vehicle (UAV). The motorised vehicles or electric scooters may be deployed by a transport system or a short distance mobility sharing system. The inventions also aim to present one or more new and useful methods of making, constructing, assembling, disassembling, installing, configuring, maintaining, managing and using the docking station. Essential features of relevant inventions are provided by one or more independent claims, whilst important or advantageous features of the inventions are presented by relevant dependent claims.

According to a first aspect, the present application provides a docking station, an automatic docking station or a docking booth for receiving one or more motorised vehicles (e.g. electric scooter). The docking station comprises a detachable connector (also known as connector) for releasably connecting or fastening a motorised vehicle to the docking station automatically; and a resource storage unit (i.e. charging unit or resource unit) that is joined to the detachable connector for replenishing (e.g. water refill) or supplying energy (e.g. electricity, gasoline, Liquefied Natural Gas) to the motorised vehicle through the detachable connector. Alternatively, the resource storage unit or charging unit is operable to join a motorised vehicle detachably or releasably for replenishing the motorised vehicle. The connector is alternatively known as a releasable connector, a detachable connector or a dock for temporarily holding, supporting, locking, joining or fastening the motorised vehicle, such as an electric scooter. The charging unit or resource unit comprises a charger connected to mains electricity or electrical/power grid, or a hose connected to a fuel storage tank. The resource unit is optionally able to replenish a docked, parked or connected motorised vehicle through its own coupling to the docked motorised vehicle, although the charging coupling and the connector may be simply or optionally integrated as a single device. In practice, the connector and the charging unit may be coupled to a motorised vehicle or electric scooter simultaneously, sequentially or separately.

The docking station is capable of connecting or holding one or more motorised vehicles simultaneously, many motorised vehicles are able to share the same docking station when necessary. Operation cost of the docking station is drastically reduced by sharing the same resource. If attached to the docking station, the motorised vehicle is able to receive resource (e.g. water, fuel or electricity) from the docking station without users' attention or effort so that an energy tank (e.g. rechargeable battery or fuel tank) of the motorised vehicle is replenished when secured to the connector. Users of the motorised vehicles are liberated from meticulous and sometimes dangerous tasks of replenishing the energy tank. In an example, AGVs that provide logistic delivery services are able to recharge or replace its battery along a journey with many docking stations, thus able to deliver goods over a long distance.

In one embodiment, the connector or any other parts of the docking station comprises one or more seals (e.g. gasket, O ring, labyrinth structure) for preventing leakage of fluid or electricity when connecting the detachable connector to the motorised vehicle. Intrusion of or dust, water or air is further possible to be prevented or reduced by the seal. The seal optionally includes one or more cushions or bumpers for providing a smooth and seamless coupling.

The connector or the coupling can be configured to be extendable, retractable, rotatable, twistable or pliable for connecting to the motorised vehicle or retractable for stowage, whether the connector or coupling is rigid, flexible, resilient foldable or in combination of these. The versatile connector facilitates easy connection to diverse sizes or models of motorised vehicles. For example, the connector comprises an alignment mechanism for guiding connection with the motorised vehicle. The alignment mechanism includes a guiding cylinder for coupling with a shaft. Optionally, the connector is rotatable, movable or slidable, tiltable or twistable manually or automatically so that minor misalignment between the connector and the motorised vehicle is easily corrected without much effort.

The charging unit may comprise one or more compartments for storing one or more resource storage cartridges, such as battery cells, power banks, battery cartridges, supercapacitors, regardless whether the batteries, battery cartridges or supercapacitors are connected to each other or the docking station. An operator of the docking station is able to replace depleted, malfunctioning or energy deficient battery cells swiftly by replacement with sufficiently charged or fully charged battery cells, making energy cartridge exchange simple, reliable and easy. The one or more resource storage cartridges may be detachable, or connectable to each other. In one embodiment the charging unit comprises an electronic circuit for powering, controlling or charging the motorised scooter.

The docking station can further comprise a base connected to the connector, the charging unit or both for supporting the charging unit, the connector or both. For example, the base includes a large plate for landing on a flat ground. The base optionally provides a smooth surface for receiving an electric scooter with small wheels effortlessly. A broad or large dimension of the base makes unauthorised shifting of the docking station cumbersome or clumsy, thus deterring theft. The base having an extensive coverage provides a counterweight to docked motorised vehicles, making them stable and upright.

The base may be operable to be fastened to a secure or immobile foundation (e.g. building wall or the ground) for secure anchoring. For example, the base is affixed to a building, a lamp pole, a floor or simply a large and heavy stone so that the base or the docking station is able to resist strong wind, rain or storm. The base can further have a broad platform or being detachable for supporting the motorised vehicle or any other parts of the docking station.

Some embodiments of the application additionally provide the docking station that moreover comprise a holder optionally connected to or integrated with the connector for supporting the motorised vehicle. The holder includes one or more prongs or boards (e.g. semi-circular shape) for joining a tube of the motorised vehicle. For example, the holder comprises electromagnets or vacuum suction cups that are able to releasably secure the motorised vehicle. The holder is possible or operable to enclose, attach or fasten to any parts (e.g. a handle bar assembly) of the motorised vehicle for holding the motorised vehicle upright. The motorised vehicle is kept in a position or orientation that is easy to handle or safe to operate when attached to the docking station.

The holder, the connector, the charging unit, the base or any part of the docking station can comprise a lock for detachably fastening the motorised vehicle to the docking station, especially when supplying the resource storage or during storage. The lock comprises an electronic lock, a mechanical lock or both. A user or an operator (e.g. technician) of the docking station is able to open one or more of the locks if having proper authorisation, such as by password entry manually, electronic signal transmission. One or more passwords or electronic signals for operating the lock may be encrypted.

The charging unit may comprise an electric coupling or adapter for connecting to a regenerative power supply, such as mains electricity, an electrical grid, a renewable resource storage source (e.g. solar panels) or resource storage harvester. The renewable resource storage source or resource storage harvester includes a wind turbine, hydro turbine, or a geothermal resource storage reservoir.

The docking station can further comprise an electronic communication signal transmission terminal (i.e. electronic communication terminal) whether wired or wireless, an electric power supply terminal whether wireless or wired, a fluid communication terminal (e.g. for water or fuel filling), a gas communication terminal (e.g. for LNG or compressed air charging) or a combination of any of these. For example, the electronic communication terminal comprises an internet connection via a network card or antenna, a RFID reader, a QR code reader, a barcode reader, a telecommunication communication terminal (e.g. 2G, 3G, 4G or other types of telecommunication protocols), a Near-Field Communication (NFC) terminal, Bluetooth communication terminal. Since most users have personal or portable communication devices (e.g. mobile phones or smartphones), the docking station is able to communicate wirelessly or seamlessly with users at their smartphones, providing pleasant, secure and easy communication with the users. The electronic communication signal transmission terminal or electronic terminal additionally include a transmitter that broadcast and/or relay information of the docking station so that multiple docking stations are mutually connected in forming an interactive network. One embodiment provides that the transmitter disseminates geographical location information via radio waves so that mobile phones or automated guided vehicles can be guided to the docking stations for charging or locking. The electronic communication signal transmission terminal or electronic terminal is optionally configured to read an electronic identification (e.g. Radio-Frequency Identification chip) of a motorised vehicle that is parked at or connected to the docking station automatically.

The docking station may additionally comprise an automatic or electronic transaction terminal (e.g. Point Of Sale (POS) or Point Of Purchase (POP)) that is connected to the connector or any other parts of the docking station for handling stowing of the motorised vehicle automatically. The transactional terminal is either standalone or connected to external devices (e.g. remote server or local smartphone) so that many users are able to pay or transact their usage of the docking station or shared motorised vehicles. The docking station thus facilitate shared resources or economy for lowering operation cost and benefiting society at large.

The connector can be configured or operable to facilitate power charging, mechanical locking and electronic transaction upon coupling to the motorised vehicle. For example, a user of the docking station is able to perform a single action (e.g. coupling or locking an electric scooter with the docking station), which accomplishes docking of the electric scooter, charging the electric scooter, paying usage of the electric scooter and transmitting data with the docking station. Data transmission can further include information exchange between the electric scooter and the docking station so that an operator of the docking station or the electric scooter is able to examine usage pattern, checking battery level, diagnosing malfunctioning, upgrading software or hardware, or awarding loyalty points to the electric scooter.

The docking station may further comprise an identification code (e.g. electronic address, electronic identification) for uniquely recognising, identifying or labelling the docking station. The identification code is either human readable, machine readable or both. For example, the identification code is a serial number in alphanumeric form, digital form, electronic form or optical form. In some cases, the identification code includes one or more electronic addresses as identification, such as a Wi-Fi address, a Bluetooth address, an IMEI (International Mobile Equipment Identity) number, an ICCID (Integrated Circuit Card Identifier) number, a telephone number, a mailing address, a device name electronically readable, a MAC (media access control) address, a website address, an IPv4 (Internet Protocol Version 4) address, an IPv6 (Internet Protocol Version 6) address, a Subscriber Identity Module or Subscriber Identification Module (SIM) (i.e. an integrated circuit for storing the International Mobile Subscriber Identity number and its related key), or any other electronic addresses. In another example, the identification code includes geographical location information, such as latitude and longitude, which provides unique location of the docking station.

The docking station can optionally comprise an user interface for interacting with users, which include a light indicator, a display screen, a touchscreen, a loud speaker, a keyboard, a computer port (e.g. VGA port), a computer mouse (a pointing device) a gesture recognition device (e.g. wired glove, depth-aware camera, stereo camera, gesture-based controller and radar) or any other tools that is able to communicate via a cable or wirelessly. For example, the light indicator includes a red LED light for indicating charging or being locked status and a green LED light for indicating battery-full status or ready to release status.

The docking station may moreover comprise one or more microcontrollers or microprocessors, and/or computer-readable memory for docking the motorised vehicle automatically. For example, the computer-readable memory installed with a computer software or firmware for controlling indicators, locking the motorised vehicle, charging the motorised vehicle or signal processing. The computer-readable memory optionally includes volatile (e.g. cache) or non-volatile memory for data storage, processing or both.

The docking station can additionally comprise a guide or motorised guide for assisting, folding, unfolding, expanding or stowing the motorised vehicle automatically or semi-automatically, especially if or when engaging one or more parts of the motorised vehicle. For example, the guide engages and lifts a latch on the handlebar assembly, a foot platform or a frame of the motorised vehicle for folding the motorised vehicle easily or effortlessly, or automatically. The motorised guide relieve effort from users so that docking or usage experience of the docking station become enjoyable or elegant. In addition of a mechanical guide, the guide can include an electric guide (e.g. flashing LED light for directing a user to dock his electric scooter) or an electronic guide (e.g. electromagnets for coupling an electric scooter to an activated or designated connector). The guide can also provide assistive force to lift, push or fold an incoming motorised vehicle. In a further alternative, the guide includes a holder that is spring-powered or foot pedal powered so that a deck plate or a rear wheel of a docked electric scooter is able to be confined and supported by the guide, and folded onto a handlebar of the electric scooter easily.

The motorised guide further may comprise a drive mechanism for withdrawing or extending the motorised vehicle. When withdrawing the motorised vehicle, the motorised vehicle is withdrawn into a compartment, being not obstructing. When extending the motorised vehicle, the drive mechanism extends a stowed motorised vehicle to a user, possible to save users' labour of unfolding.

The docking station can further comprise a shelter for preventing intrusion of sunlight, rainwater or dust to the docking station, the motorised vehicle or both. The shelter includes a board, a tent, a roof, a sunshade or a barrier that protects the docking station, a stowed motorised vehicle or a user.

The docking station may further comprise a monitor for observing operation of the docking station, such as electric power charging, theft, transaction, security, image or sound recording. The monitor may be able to record or observe images, sound, vibration or any other parameters (e.g. temperature, voltage). The monitor is possible to include different types of sensor, which observes light, motion, temperature, magnetic fields, gravity, humidity, moisture, vibration, pressure, electrical field, sound, and other physical aspects of environment. For example, the monitor includes a security camera that automatically record images of the docking station if detecting motion.

The docking station can further comprise an alarm for providing warning, either electrically to other equipment, human or animals, if experiencing malfunctioning or theft. The alarm can incorporate or separate audio signal, video signal (e.g. flash light) or electronic signal.

The docking station sometimes further comprises one or more repellers (e.g. mechanical type, electrical type or chemical types) or protector for driving or keeping pest (e.g. birds, cockroaches, rodents, ants) away from the docking station or the motorised vehicle so that the docking station or the motorised vehicle is well-preserved.

The docking station at times further comprises a light source, a light reflector, or an electric lamp, which is possibly connected to the charging unit for illuminating a part of the docking station for easy docking. Hence, the docking station is clearly visible from a distance in the nights, and facilitates smooth usage at dark places.

The docking station can further comprise a cleaning tool (e.g. air gun or brush) for cleaning the docking station, the motorised vehicle, users or any of these. The cleaning tool makes cleaning of the docking station or motorised vehicles neat and unsoiled over prolonged period of usage.

The present application also provides a docking harbour or bay for keeping multiple motorised vehicles. The docking harbour comprises a first docking station and a second docking station; and a common platform or stand for detachably or releasably joining the first docking station and the second docking station together. In other words, the docking harbour include multiple docking stations that possibly share resource or facilities together. For example, the first docking station and the second docking station have a common roof, a common base or both. Since many docking stations are able to share resources together, such as by sharing solar panels, the docking harbour become more efficient or incur less cost. Similar to a docking station, the docking harbour may further comprise an identification code (e.g. electronic address, electronic identification) for uniquely recognising, identifying or labelling the docking harbour.

The charging unit may be configured or operable to replenish an electric scooter as a motorised vehicle according to a charging protocol. The electric scooter is electrically or battery powered so that one or more rechargeable batteries of the electric scooter need to be recharged to achieve the longest driving distance or longest battery life. For example, during day time (i.e. 06:00˜18:00), the charging unit does not charge a rechargeable battery (Li-ion battery) on an electric scooter if the electric scooter is returned to the docking station with 50% battery power balance. Nevertheless, during night time (i.e. 24:00˜06:00), the charging unit will charge the rechargeable battery to the full if the electric scooter is returned to the docking station, regardless remaining battery level of the electric scooter. Of course, the charging protocol will not charge or automatically stop charging if battery level of an electric scooter is detected to be more than 90%. The charging protocol additionally monitors charging time of every electric scooter so that deterioration or aging of the rechargeable battery is closely observed. Alternatively, the charging protocol is optimised toward prolonging battery's life, achieving shortest charging time or balancing docking station's power balance between input and output.

Embodiments of the application provides that the docking station is mobile. For example, the docking station is automated guided vehicle or automatic guided vehicle (AGV) that is able to move around for replenishing motorised vehicles at desired locations. For example, the mobile docking station moves to residential areas after peak hours or during public holidays, and moves to Central Business District areas during peak business hours. The mobile docking station includes a mobile battery pack that is able to be connected to an electric scooter. The electric scooter may continue to be used even if its on-board battery is depleted, after coupling with the mobile battery pack. In fact, a first electric scooter may serve as a mobile docking station for a second scooter if the first electric scooter is coupled to the second electric scooter, and charge a battery of the second scooter, whether both electric scooters are moving or not.

According to a second aspect, the present application provides a method of using a docking station for a motorised vehicle. The method comprises a first step of connecting a motorised vehicle; a second step of checking or detecting resource level of the motorised vehicle; and a third step of releasing the motorised vehicle upon user or operator activation. Some of these steps may be changed in sequence or combined. These method steps require simple and almost effortless handling from users so that the docking station can be reliably, durably, simply and intuitively operated.

The method optionally comprises a step of fastening or locking the motorised vehicle to the docking station. The motorised vehicle is able to be secured, replenished (e.g. refuelled or recharged), electronically registered or transacted within few steps.

The method can additionally comprise a step of communicating (e.g. diagnosing, electronically transacting, monitoring, repairing, upgrading, configuring, updating) with the motorised vehicle. Therefore, regular or continuous maintenance of the motorised vehicle or the docking station is automatically performed, making both the docking station and the motorised vehicle reliable and in excellent condition.

The method may further comprise a step of contacting automatically a remote computer or computing server for transaction or system backup. Particularly, the docking station is able to contact a remote control centre via a telecommunication network, a Wi-Fi connection or an intranet. For example, the docking station is able to communicate to a computing server via TCP/IP (Transmission Control Protocol or Internet Protocol) data network, which includes wide area networks (WAN), metropolitan area networks (MAN), local area networks (LAN), Internet area networks (IAN), campus area networks (CAN) and virtual private networks (VPN). The telecommunication network includes 0G, 1G, 2G, 3G, 3.5G, 4G, 4.5G and 5G wireless telephone technology (mobile telecommunications).

The method can further comprise a step of energising (e.g. electrically charging) the motorised vehicle or the docking station, if required or demanded. For example, a depleted battery removed from the motorised vehicle or the docking station, whilst a fully charged battery is inserted into the motorised vehicle or the docking station. Exchange of the batteries is fast to perform, and the depleted battery is either charged by a charging unit of the docking station (e.g. solar panels) or replaced by an operator of the docking station.

Embodiments of the docking station provides one or more RFID readers, charging control protocols, indicator control modules, lock control schemes. The docking station is able to be integrated these parts or functions that make the docking station more user friendly and simple to operate.

The docking stations are meant for storing and charging e-scooters in a mobility sharing system where specially designed e-scooters are provided for rental. The docking stations are capable of locking e-scooters, automatically identifying e-scooters' ID, and communicating with a remote server. Moreover, the docking stations are capable of charging e-scooters according to the charging protocol predefined in the docking station or received from the remote server and releasing e-scooters upon receiving the release command from the remote server. A docking station consists multiple docking points, where each docking point can store one e-scooter. A docking station may also comprise a terminal.

The present application provides a docking station that has following advantages.
1. No civil work: When deploying such docking stations, mounting them into the ground or against walls can be costly, time consuming, and maybe limiting the places where they can be deployed. Therefore, we have designed a standalone docking station that requires no civil work to deploy. A few docking points are mounted into a heavy metal base, which acts as a counterweight to stabilize the docking station.
2. Battery-powered: In certain situations, where tapping into the power grid or using solar panel is challenging, we use swappable batteries to supply power to the docking stations. The batteries are to be swapped at the end of the daily operation and recharged.
3. Anti-theft/vandalism: The station is equipped with vibration sensors that are able to detect unauthorized movement of the docking stations.
4. Guided folding: Folding a scooter can be tricky and requires certain effort. Even everyday users may not be able to get it right with one try every time. In a sharing system that requires folding, when a user pushes an e-scooter into a docking station, the docking station automatically lifts the latch so that the e-scooter can be folded easily.
5. Charging protocol: When an e-scooter is returned to the docking station, the docking station is able to read its remaining battery. Based on this reading and the prediction of future uses, a decision of whether to charge the e-scooter and how to charge it will be made by the docking station locally or by the remote server and then pass the command to the station.

According to another aspect, the present application provides a docking station for a transport system. The docking station comprises a holder for receiving an electric scooter; and a hub connector for connecting the electric scooter. The holder optionally comprises a lock for fastening the electric scooter. The lock possibly comprises a chain or electromagnets for receiving a handle of the electric scooter. The holder sometimes comprises one or more walls for supporting the electric scooter. The one or more walls comprises a slot for surrounding at least a part of the electric scooter. The hub connector can comprise electric terminals for coupling with the electric scooter. The electric terminal may comprise wireless terminals. Embodiments of the hub connector is ingress protected. Some embodiments of the docking station provide further comprise one or more indicators for signifying status of the electric scooter, the docking station or both. In one example, the hub connector further comprises a power supply. In another example, the hub connector comprises an energy harvester for powering the docking station locally. Optionally, the docking station further comprise a panel for protecting the electric scooter from ambient air, water, heat, sunlight and noise. The holder possibly further comprises a fixture for anchoring to a stationary base. The docking station can further comprise an electronic identification for reading by an electronic device. The docking station may further comprise a grapple for folding the electric scooter onto the docking station. The docking station can additionally comprise a mechanical arm for fetching the electric scooter. The docking station may further comprise a chain.

The present application additionally provides an electric scooter harbour for keeping electric scooters. The docking bay comprises a first docking station (e.g. the docking station mentioned earlier) and a second docking station (e.g. the docking station mentioned earlier). The first docking station and the second docking station are attached together. The electric scooter harbour can further comprise a carrier that is connected to the first docking station and the second docking station for transporting the two stations. The electric scooter harbour may further comprise a power supply unit for supplying electricity to the first docking station, the second docking station or both. The electric scooter harbour optionally further comprises a frame that holds the first docking station and the second docking station together.

The docking station of the present application may be able to receive and release an electric scooter automatically or by a rider of the electric scooter. The docking station is further able to hold the electric scooter upright, folded or vertically stacked up so that a footprint of the docking station and the electric scooter is small. The docking station is possible to made modular such that multiple pieces of the docking station are able to joined together (e.g. stacked vertically or laid out laterally), occupying little space.

During storage, the docking station is able to monitor, secure or charge one or more electric scooters so that the one or more electric scooters are ready for use if detached from the docking station. The docking station is able to communicate with one or more electronic devices via cables or wirelessly. For example, the docking station is able to exchange data with a remote computing server via 4G telecommunication network. The docking station is further able to exchange information with a rider via a mobile phone (e.g. via Bluetooth communication with the mobile phone).

Multiple pieces of the docking station can be horizontally connected, vertically stacked or grouped as modules. Hence, the docking station is easily transported, dismantled and reassembled onsite to store electric scooters at any place when required. The docking station is also robust, versatile and simple, making them reliable, attractive and easy to implement for electric scooter riders around a city.

According to an aspect, the present application provides a docking station for a transport system. The docking station comprises a stationary holder for receiving a steering tube/pole/post/bar/shaft or a footrest/pedal of an electric scooter; and a hub connector on or connected/attached to the holder for electrically connecting the electric scooter at rest. The holder optionally comprises a lock for fastening the electric scooter, whilst the lock is preferably configured to detachably receive or release the electric scooter.

Some embodiments of the application provide that the holder has at least one hanger for keeping the electric scooter vertically. The holder comprises a lock for fastening (at least a part of) the electric scooter. The lock comprises a chain or electromagnets for receiving a handle (or any other parts) of the electric scooter. The holder comprises at least one wall for supporting the electric scooter (vertically, horizontally, in a predetermined orientation or a combination of any of these). The at least one wall comprises a slot for surrounding at least a part of the electric scooter. The hub connector comprises electric terminals for coupling with the electric scooter (in order to charge, communication, or both). The electric terminal comprises wireless terminals. The hub connector is ingress protected (IP code, IEC & EN 60529). The docking station further comprises one or more (visual, audio, wireless, mobile phone connectable) indicators for signifying status of the electric scooter, the docking station or both. The hub connector further comprises an electric power supply for charging the electric scooter, powering the docking station or communicating with a remote control centre. The hub connector comprises an energy harvester for powering the docking station locally (e.g. solar panel, wind turbine or other types of renewable energy harvesters). The docking station further comprises a panel, which may be a part of a building envelope for protecting the electric scooter from ambient (or environmental) air, water, heat, sunlight and noise. The docking station comprises multiple panels for enveloping the electric scooter fully or partially. The holder further comprises a fixture for anchoring to a stationary base. The docking station further comprises an electronic identification for reading by an electronic device (e.g. mobile phones, computing server, barcode reader, RFID, etc.). The fixture includes holes for chains or screws or base plate for ground attachment. The panel comprises a roof, a wall, a floor, a window and a ventilation orifice. The docking station further comprises a grapple for folding the electric scooter onto the docking station. The docking station further comprises a mechanical arm for fetching the electric scooter. The docking station further comprises a chain, a user interface (e.g. LCD screen).

Embodiments of the application further provides an electric scooter harbour for keeping electric scooters. The docking harbour comprises a first docking station and a second docking station. The first docking station and the second docking station are attached together contiguously. For example, openings or receptacles of the docking stations face the same direction, or opposite to each other. The electric scooter harbour further comprises a carrier that is connected to the first docking station and the second docking station for transporting the two stations. The carrier comprises a power supply unit, a roof, supporting pillars or a frame so that the carrier becomes unitary for easy transport. The electric scooter harbour further comprises a power supply unit for supplying electricity to the first docking station, the second docking station or both. The electric scooter harbour further comprises a frame that holds the first docking station and the second docking station together (vertically, horizontally or both).

The accompanying figures (Figs.) illustrate embodiments and serve to explain principles of the disclosed embodiments. It is to be understood, however, that these figures are presented for purposes of illustration only, and not for defining limits of relevant inventions.

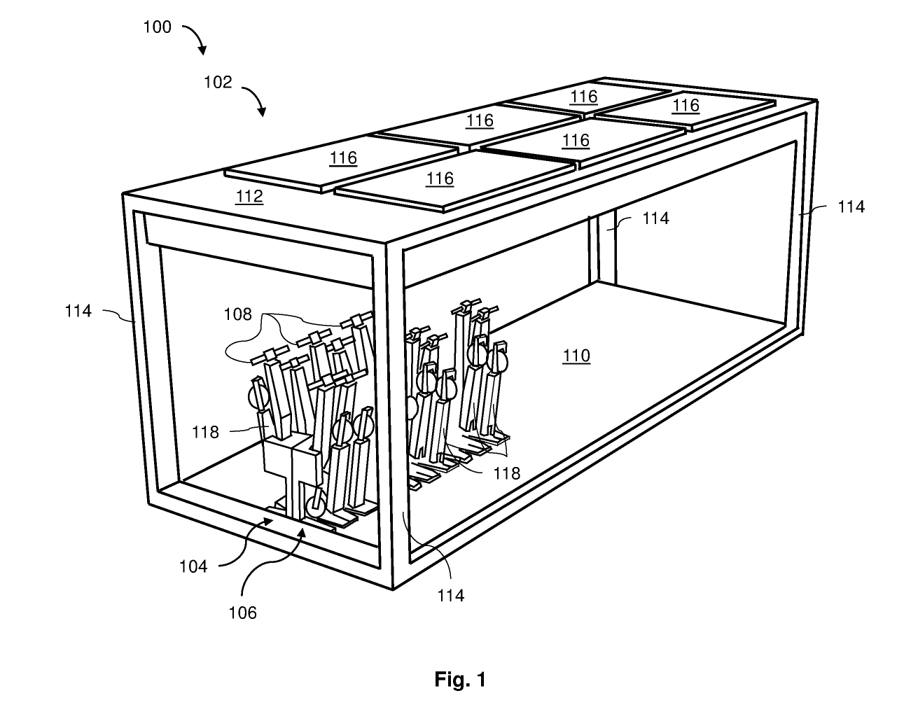

FIG. 1 illustrates a first docking station;

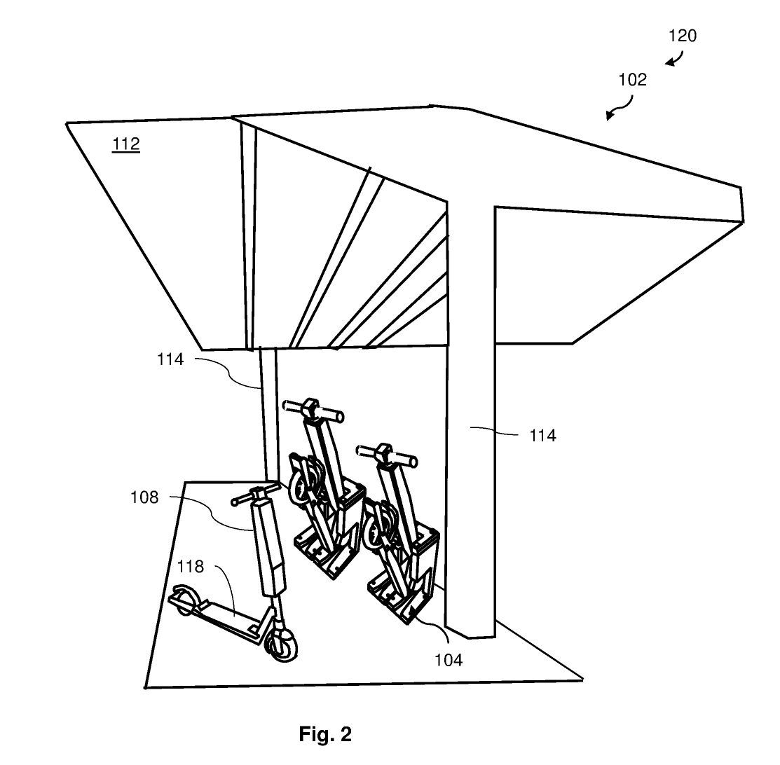

FIG. 2 illustrates a second docking station;

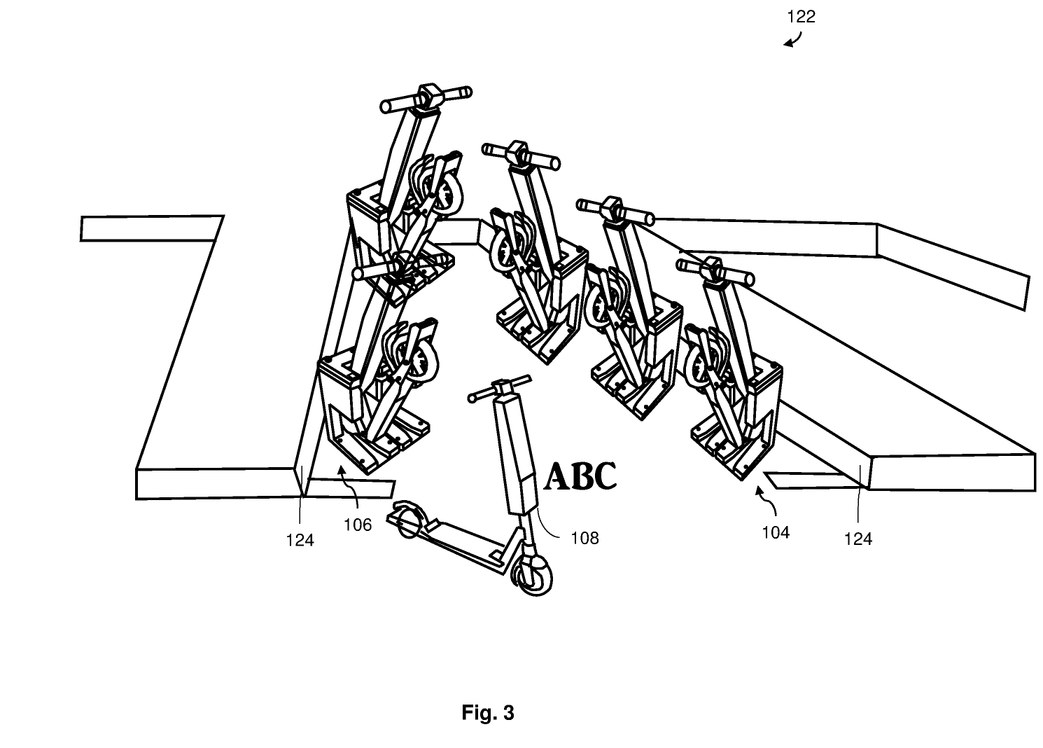

FIG. 3 illustrates a third docking station;

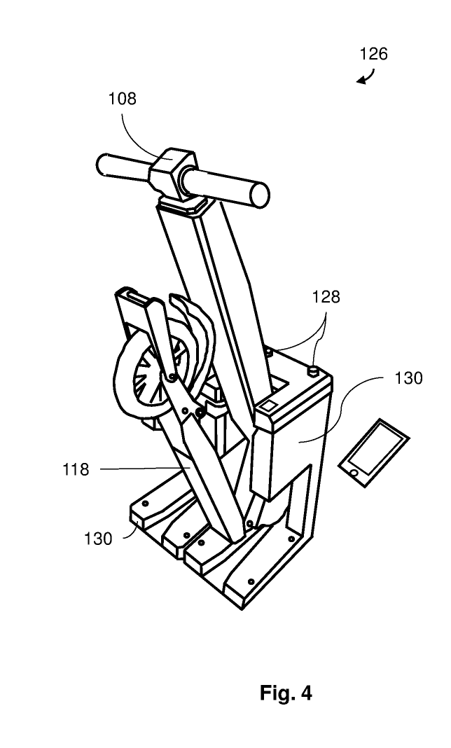

FIG. 4 illustrates a fourth docking station at a transport hub;

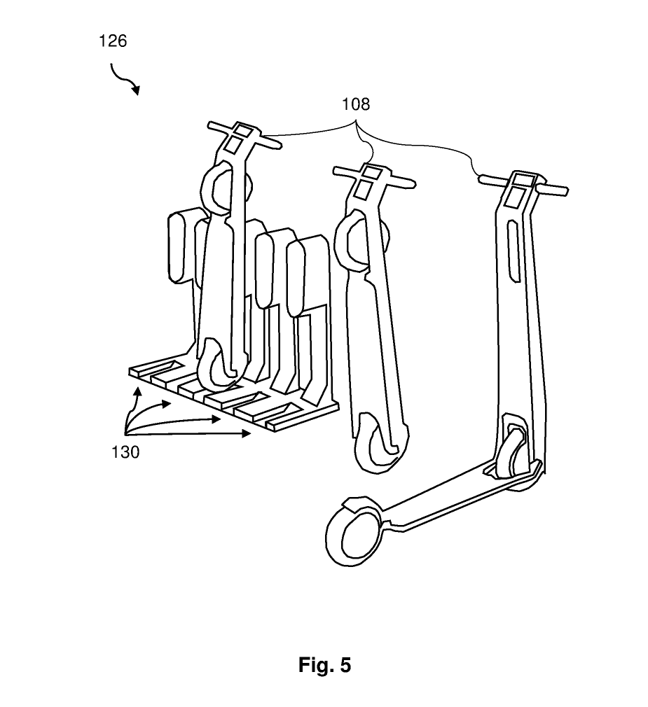

FIG. 5 illustrates the fourth docking station with foldable electric scooters;

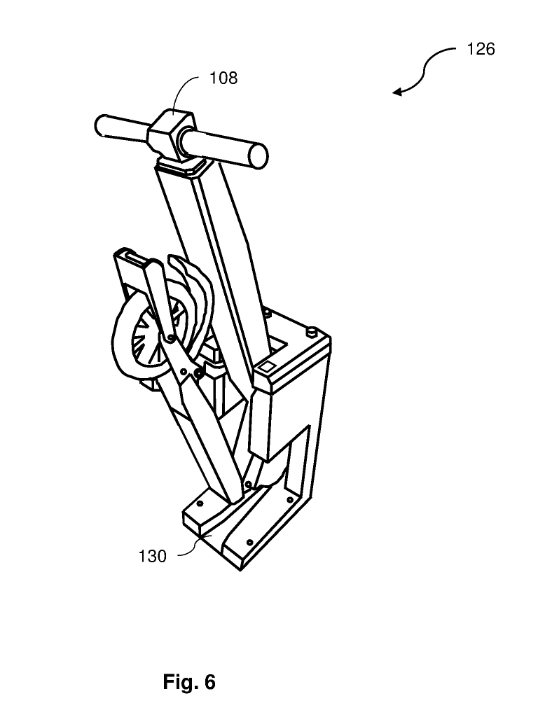

FIG. 6 illustrates the fourth docking station with a foldable electric scooter;

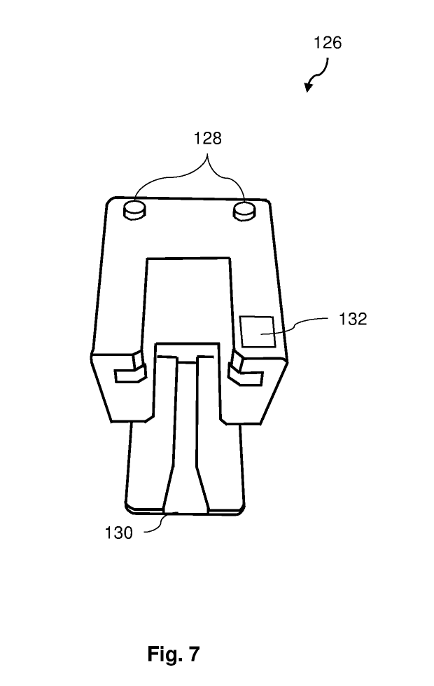

FIG. 7 illustrates the fourth docking station exposed;

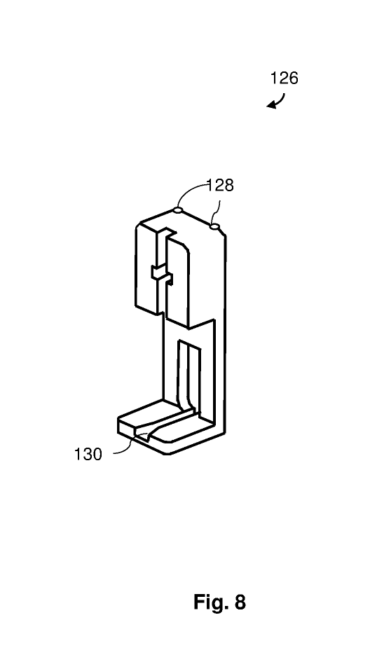

FIG. 8 illustrates an isometric view of the fourth docking station;

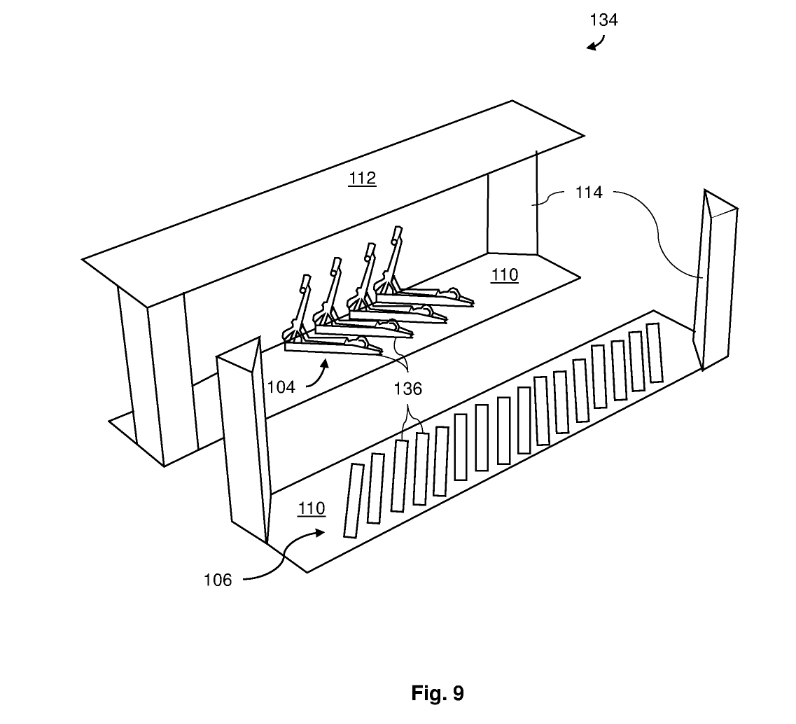

FIG. 9 illustrates a fifth docking station;

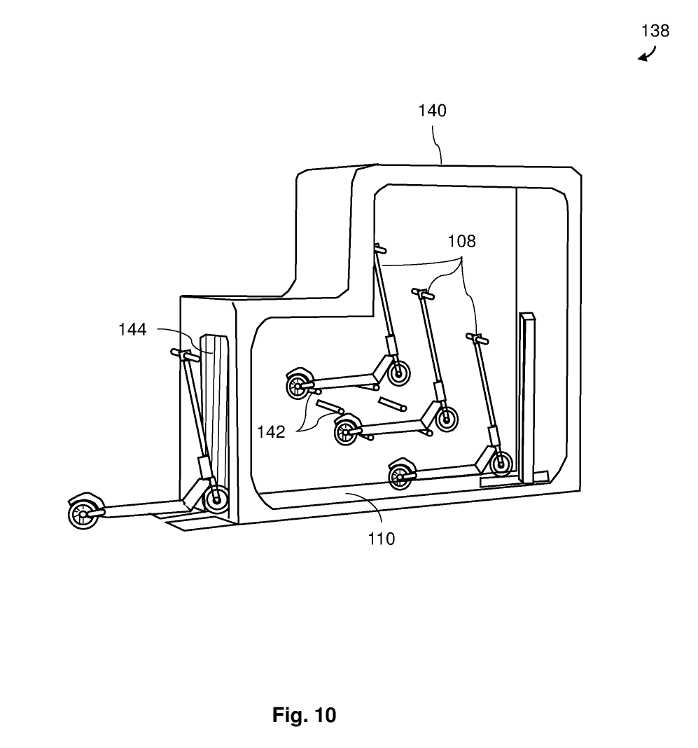

FIG. 10 illustrates a sixth docking station;

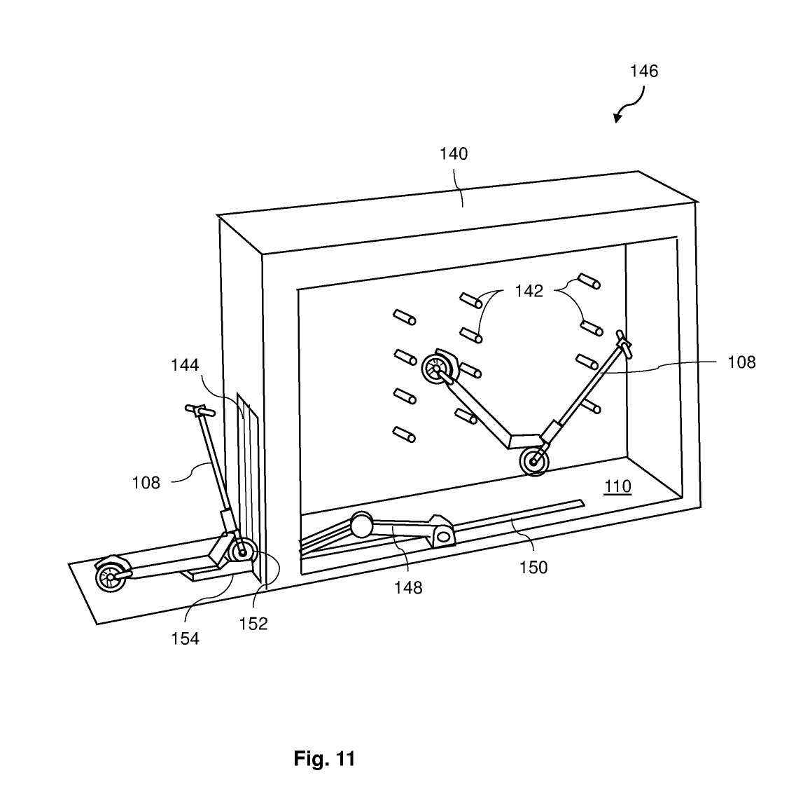

FIG. 11 illustrates a seventh docking station;

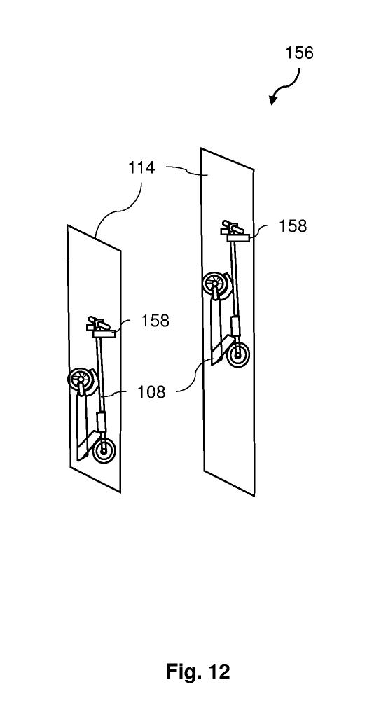

FIG. 12 illustrates an eighth docking station;

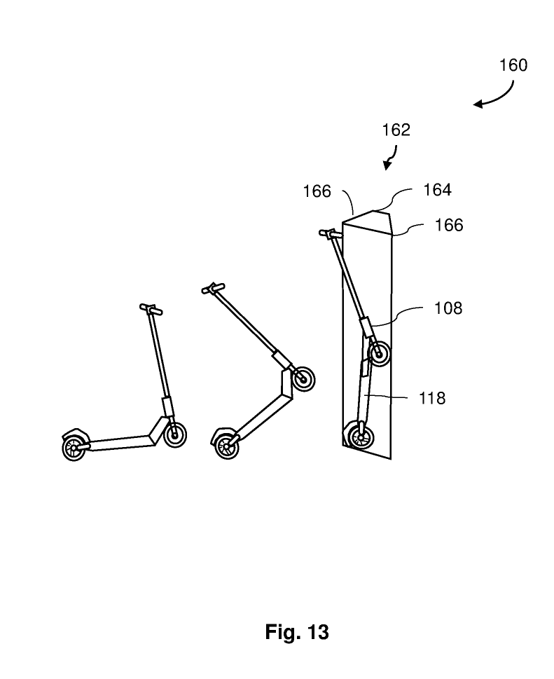

FIG. 13 illustrates a ninth docking station;

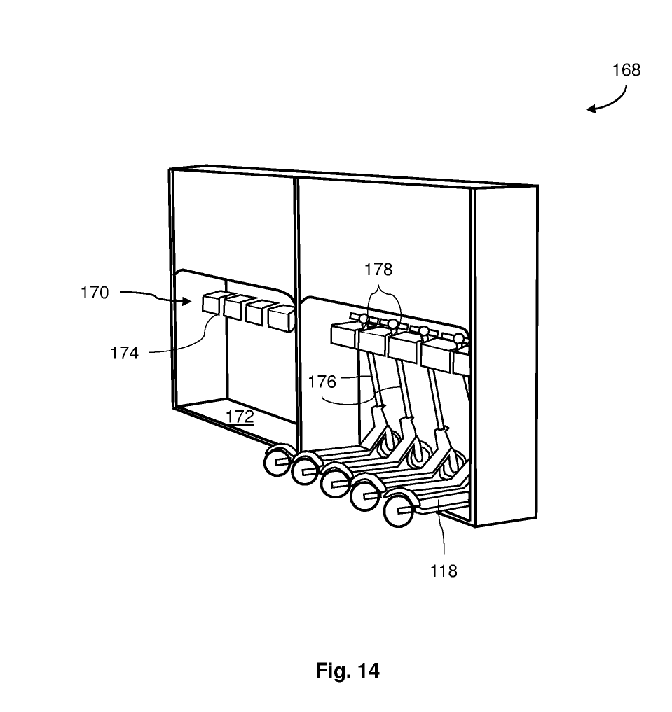

FIG. 14 illustrates a tenth docking station;

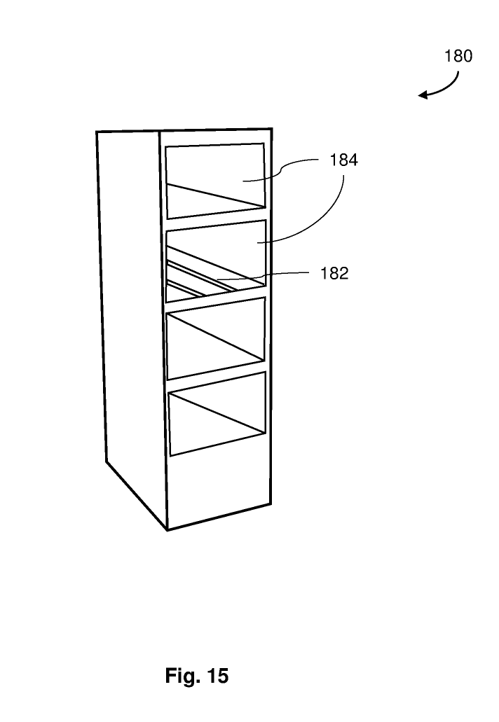

FIG. 15 illustrates an eleventh docking station;

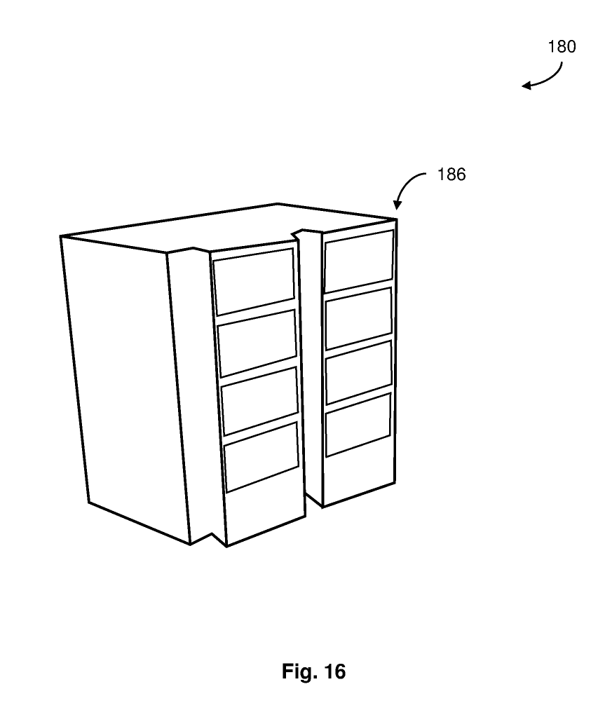

FIG. 16 illustrates a first cluster of the eleventh docking stations;

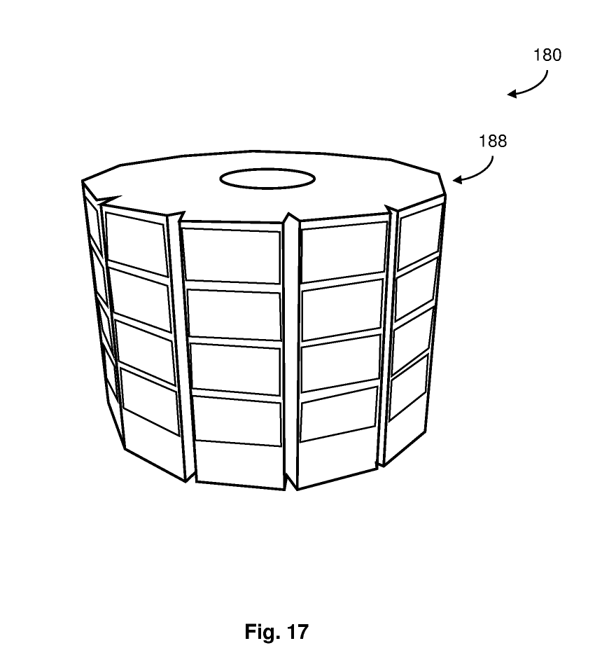

FIG. 17 illustrates a second cluster of the eleventh docking stations;

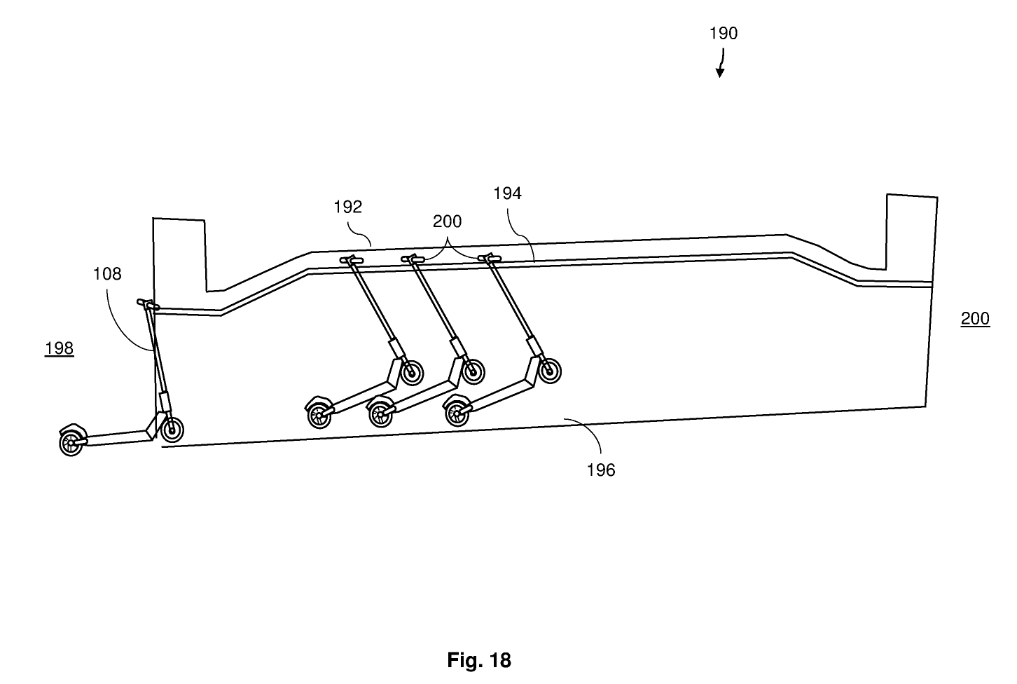

FIG. 18 illustrates a twelfth docking station;

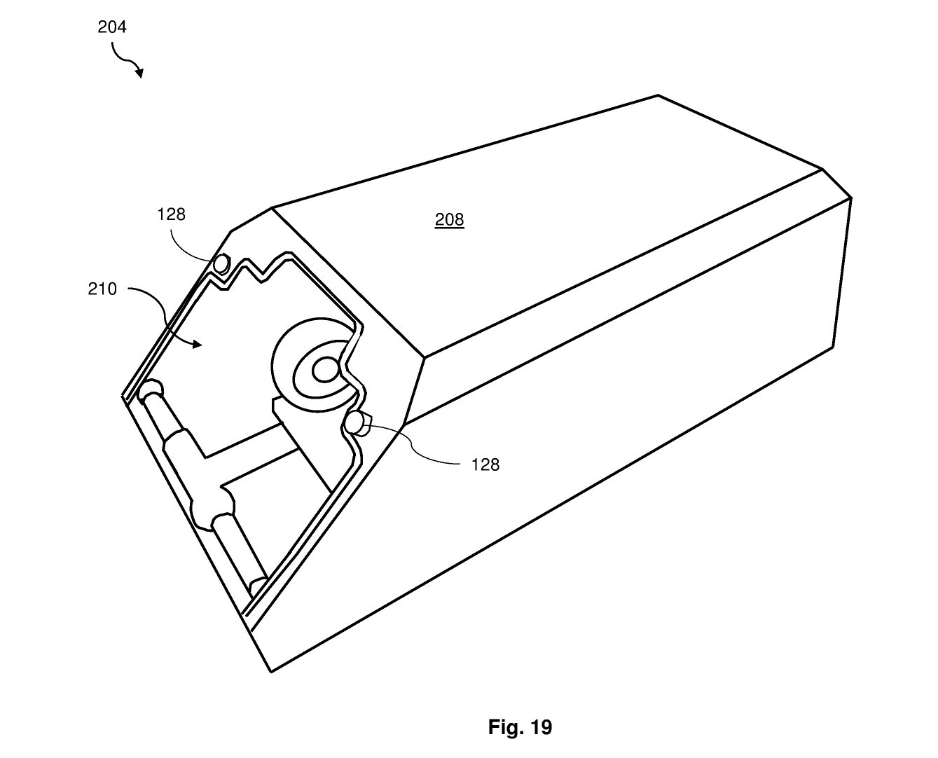

FIG. 19 illustrates a thirteen docking station;

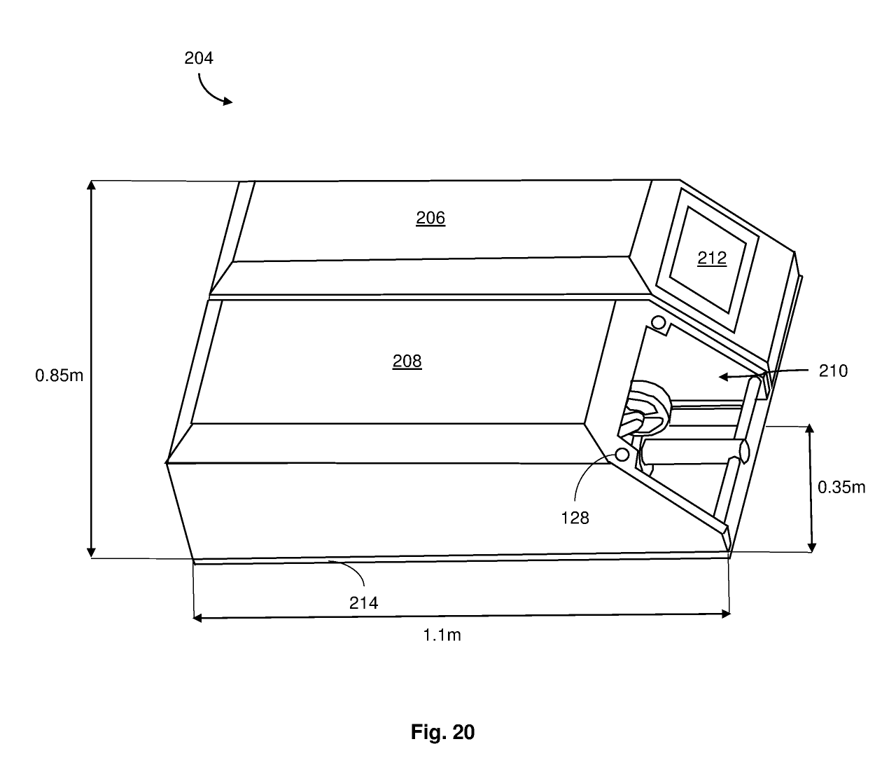

FIG. 20 illustrates another view of the thirteen docking station;

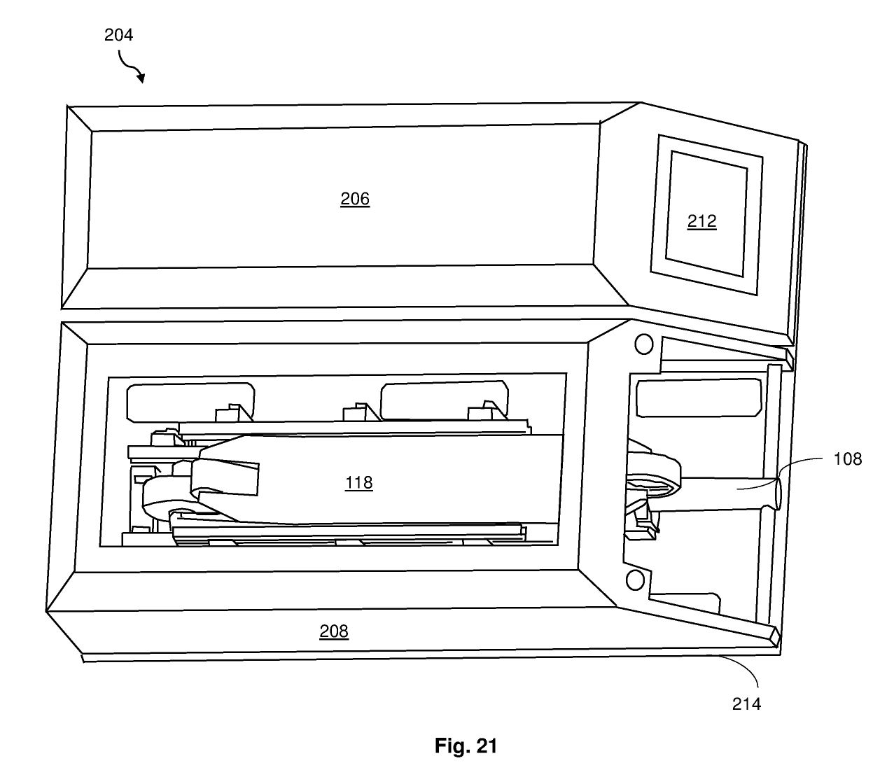

FIG. 21 illustrates the thirteen docking station being partially exposed;

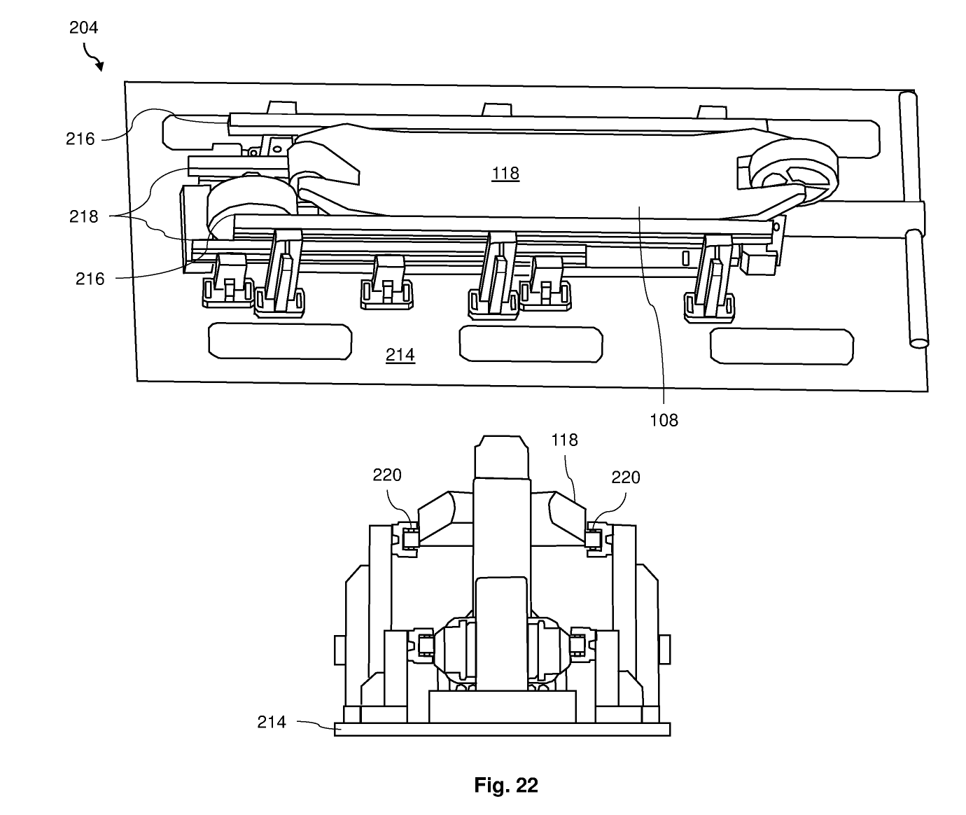

FIG. 22 illustrates internal mechanism of the thirteen docking station;

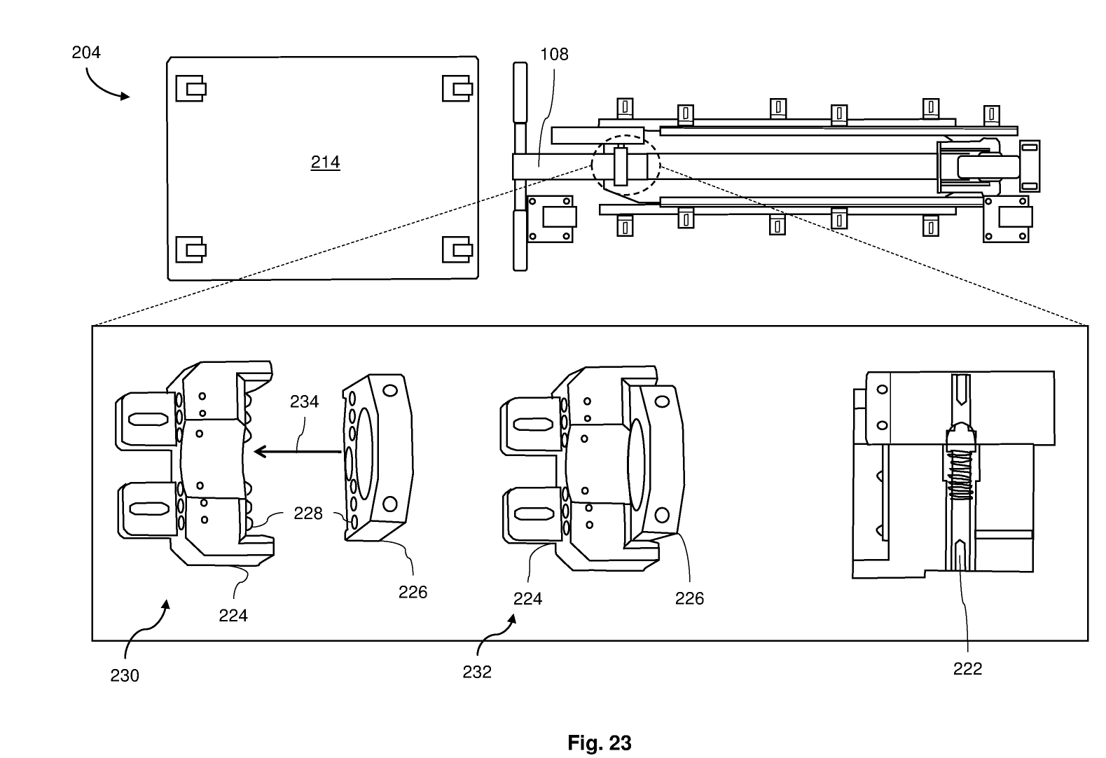

FIG. 23 illustrates locking and charging mechanism of the thirteen docking station;

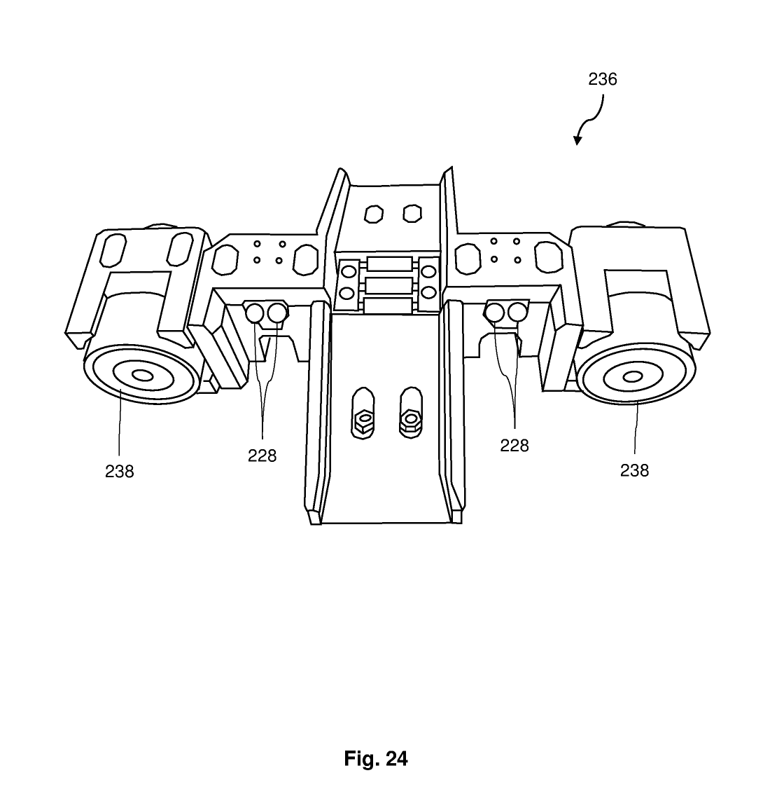

FIG. 24 illustrates a hub connector of the thirteen docking station;

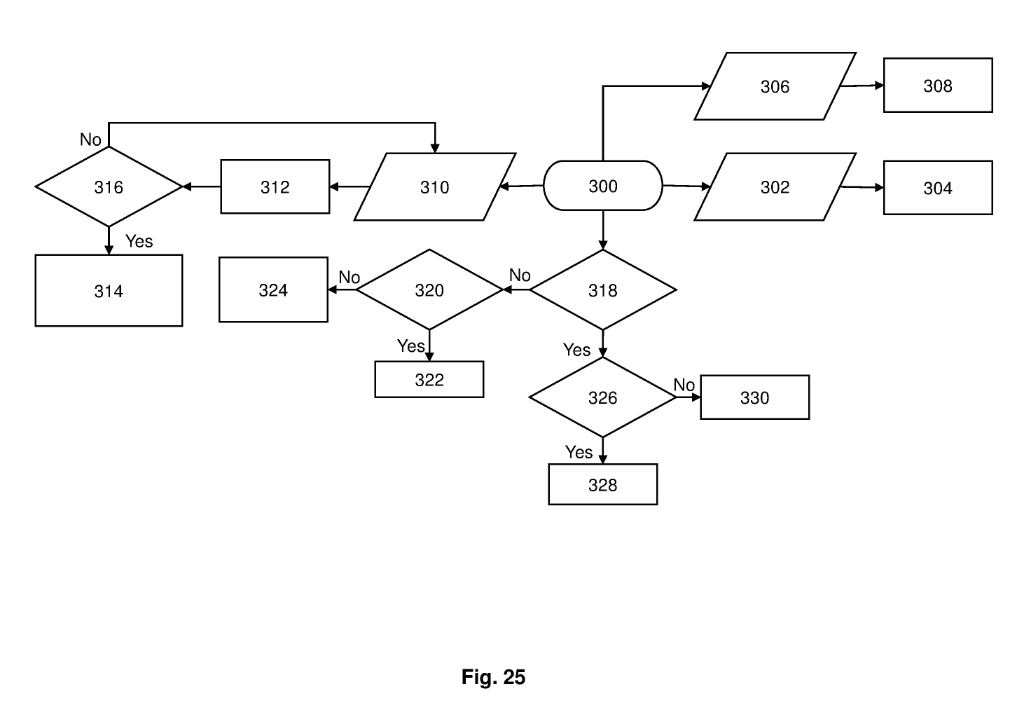

FIG. 25 illustrates a process flow chart of the docking station;

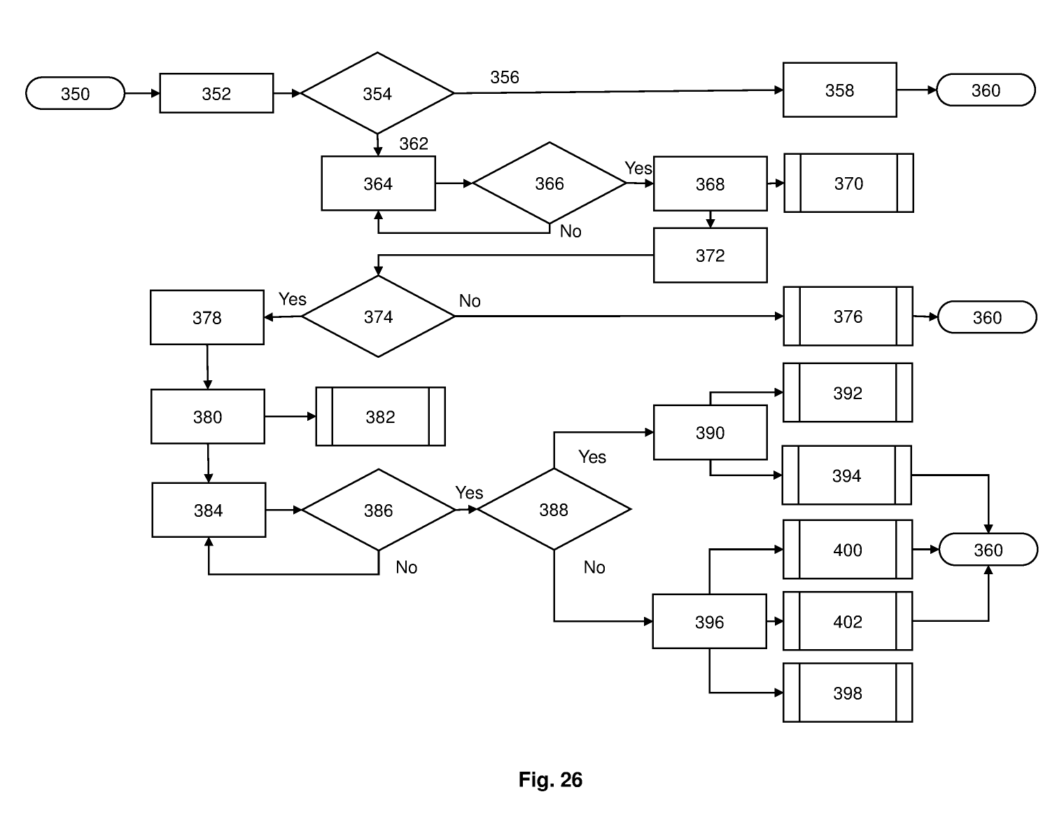

FIG. 26 illustrates an operation process of the docking station;

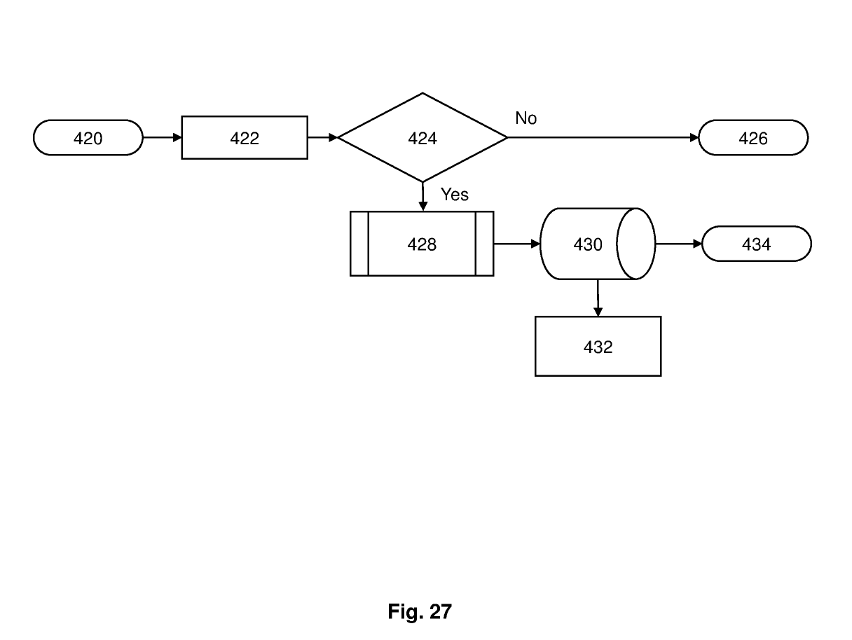

FIG. 27 illustrates a process flow chart of a vibration alarm of the docking station;

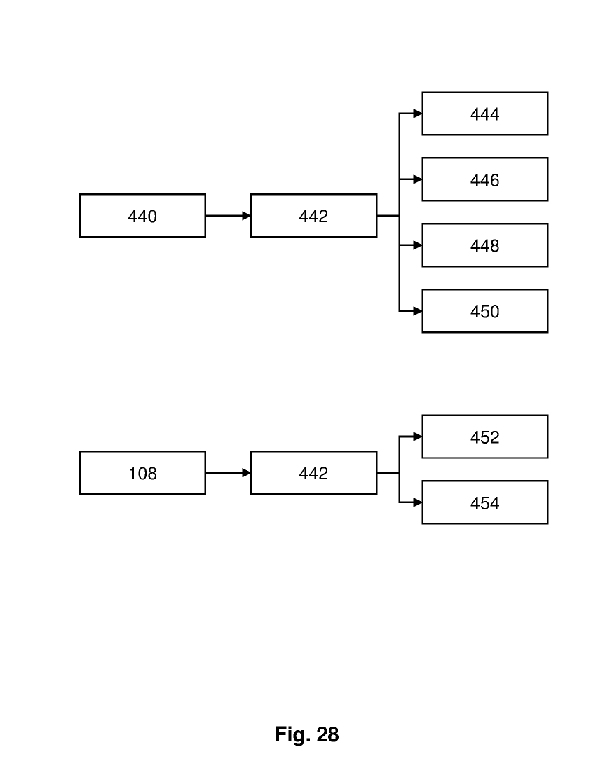

FIG. 28 illustrates some electronic components of the docking station and its corresponding electric scooter controlled by 3G module; and

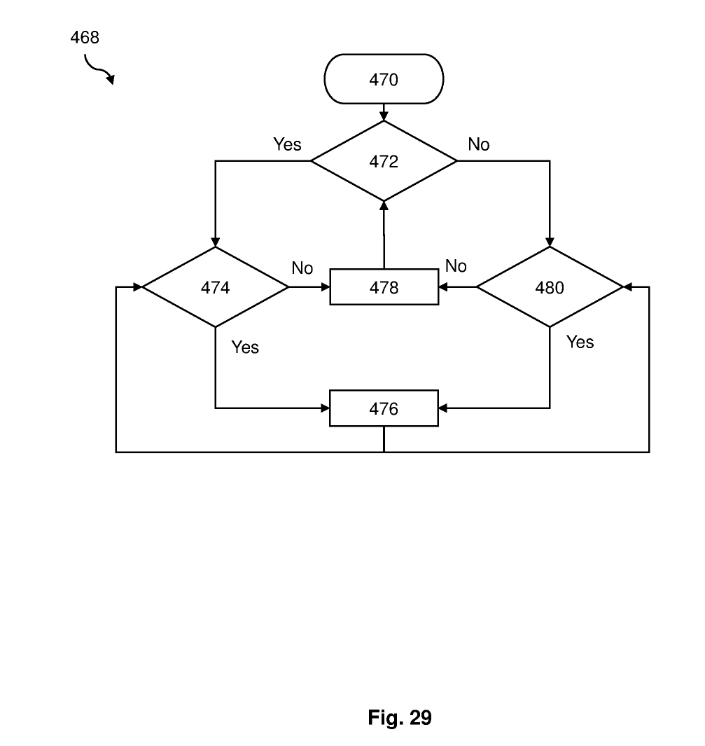

FIG. 29 illustrates a process flow chart of a charging protocol of the docking station.

Exemplary, non-limiting embodiments of the present application will now be described with references to the above-mentioned figures.

FIG. 1 relates to a first embodiment of the present application. In particular, FIG. 1 illustrates a first docking station 100. The first docking station 100 comprises a shelter 102, a first row of holders 104 and a second row of holders 106, together with arrays of foldable electric scooters 108 in the holders. The shelter 102 includes a floor 110 and a ceiling 112 that are supported and connected together by four pillars 114 at four corners of the shelter 102. The ceiling additionally has six solar panels 116 that are laid on top of the ceiling 112, being exposed to sunlight. The two rows of holders 104,106 are attached to each other back-to-back such that their openings are on opposite sides. Bases of the two rows of holders 104,106 are firmly fixed to the floor such that the floor 110 and the two rows 104,106 become unitary. Each of the holders 104,106 is inserted with an electric scooter 108, which is fully folded into openings of the holders 104,106 respectively. Footrests 118 of the electric scooters 108 are folded onto steering tubes such these electric scooters 108 are closely attached to their holders 104,106 respectively, having small footprints for storage. The first docking station 100 is modular such that the first docking station 100 is able to be lifted and transported to any places when required.

FIG. 2 relates to a second docking station 120, which is a second embodiment. The second embodiment comprises parts or method steps that are similar or identical to those of the first embodiment. Description of the similar or identical part or method steps is hereby incorporated by reference, wherever relevant and appropriate.

The second docking station 120 includes a first row of holders that are cemented to ground. The first row is placed between pillars 114 of a bus shelter 102 in a middle position of the bus shelter 102. Several electric scooters 108 are folded into openings of the first row 104, and footrests 118 of the electric scooters 108 are similarly folded onto steering tubes of the electric scooters 108. A width of the folded electric scooters 108 is comparable to a width of the pillars 114 of the bus shelter 102. A walk path of the bus shelter 102 remains sufficiently wide for pedestrians, presenting no hindrance or restriction to the pedestrians or bus passengers.

FIG. 3 illustrates a third docking station 122, which is a third embodiment. The third embodiment comprises parts or method steps that are similar or identical to other embodiments. Description of the similar or identical part or method steps is hereby incorporated by reference, wherever relevant and appropriate.

The third docking station 122 has a first row 104 and a second row 106 that are detached from each other. According to FIG. 3, the two rows 104,106 are placed on opposite sides of Parking Lot Number 82, which is inside a residential area. Bases of the two rows 104,106 are firmly planted on the ground, and closely attached to opposite kerbs 124 respectively. The electric scooters 108 are folded too, being closely attached to the two rows 104,106 of docking station(s). A distance between the two rows is about two metres such that a rider can easily access any of the docked electric scooters 108 via a lane between the two rows 104,106, and remove an electric scooter 108 for riding off.

FIGS. 4 to 8 relates to a fourth embodiment of the application. Particularly, FIG. 4 illustrates a fourth docking station 126 at a transport hub. The transport hub is a MRT (Mass Rapid Transit) station which has many underground lines of a city. The fourth docking station 126 has two receptacles 130 or openings for receiving folded electric scooters 108. According to FIG. 4, a user folds an electric scooter 108 such that a footrest 118 of the electric scooter 108 is attached to a steering tube of the electric scooter 108 such that the electric scooter 108 becomes a compact block, being locked into a receptacle of the fourth docking station 126. Each of the receptacles 130 has two coloured light indicators 128, being a red for sounding alarm and a green for showing secure locking.

FIG. 5 illustrates the fourth docking station 126 with foldable electric scooters 108 in a conceptual form. Four receptacles 130 are provided by FIG. 5 such that the docking station 126 is able to hold four folded electric scooters 108. Electric scooters 108 are shown to be folded for storing and expanded for riding, offering options to riders of the electric scooters 108.

FIG. 6 illustrates the fourth docking station 126 with a foldable electric scooter 108; FIG. 7 illustrates the fourth docking station 126 exposed; and FIG. 8 illustrates an isometric view of the fourth docking station 126. FIG. 7 provides a QR (Quick Response) code 132 label on top of the docking station 126. FIG. 8 additionally multiple functions of the fourth docking station 126, which include indicating station weather data, showing station availability, displaying locking status, exhibiting charging voltage and current values (V & I), communicating with a remote computing server and revealing usage data of the electric scooter 108. The fourth docking station 126 is an intelligent post that also provides a communication hub between registered electric scooters 108 and the remote computing server.

FIG. 9 illustrates a fifth docking station 134, which comprises two ranks of holders 104,106. A first rank 104 has pillars that are held between respective floors 110 and ceilings 112. Each of the ceilings 112 and floors 110 are supported by two pillars 114 at opposite ends such that an open area between the two pillars 114 is made available for parking electric scooters 108. Each of the floors 110 has a guiding chute 136 for anchoring electric scooters 108. Wheels of an electric scooter 108 are supported by walls of the guiding chute 136 so that a docked electric scooter 108 remains standing in the guiding chute 136. The docked electric scooter 108 is further locked to the guiding chute 136 during storage. The ceilings 112 prevent rain, dust, leaves or other foreign objects from falling onto docked electric scooters 108. Ceilings 112 of a second rank 106 are removed such that guiding chutes 136 of the second ranks 106 are exposed for better illustration. Each of the electric scooters 108 can be easily accessed, removed or docked at the guiding chutes 136 at any time.

FIG. 10 illustrates a sixth docking station 138. The sixth docking station 138 is a sealed cabinet 140, although a lateral side of the sealed cabinet 140 is removed for better illustration. The sixth docking station 138 having horizontal internal bars 142 relative to the floor 110 that hold and stack electric scooters 108 inside a casing of the sixth docking station 138. The sixth docking station 138 further has a soft curtain 144 for covering a front side of the sixth docking station 138. An electric scooter 108 is able to be pushed through the soft curtain 144 for storage inside the sixth docking station 138, being automatically stacked up inside the sixth docking station 138.

FIG. 11 illustrates a seventh docking station 146, which is another sealed cabinet 140. Similar to the sixth docking station 138, the seventh docking station 146 has two arrays of internal bars 142 for holding two stacks of electric scooters 108 internally. The seventh docking station 146 additionally has a robotic arm 148 that is movable on a rail 150 on a floor 110 of the seventh docking station 146. The robotic arm 148 has an end-effector 154 for capturing a front wheel 152 and a footrest 118 of an electric scooter 108 such that the robotic arm 148 is able to receive, lock, lift and release an electric scooter 108 for storage inside the seventh docking station 146.

FIG. 12 illustrates an eighth docking station 156. The eighth docking station 156 comprises a pillar 114 with several vertically aligned holders 158 at a side. The holders are able to support handles, wheels and a footrest of an electric scooter 108 vertically so that a folded electric scooter 108 is able to be held closely to the pillar 114 for storage. Optionally, the holders 158 are movable along the pillar 114 so that multiple electric scooters 108 are able to be stored on the same pillar 114 or docking station 156.

FIG. 13 illustrates a ninth docking station 160, which primarily has a vertically standing chute 162. The chute 162 has a front opening for receiving an electric scooter 108, whilst two lateral sides of the chute 162 face each other. A ridge of the chute 162, which joins the two lateral sides, has holders (not shown) to engage wheels, footrests 118 and handles of electric scooters 108 such that an electric scooter 108 is able to be held vertically and stored inside the chute 162.

FIG. 14 illustrates a tenth docking station 168. The tenth docking station 168 has two rows of storage cabinets 170, whilst each of the two rows have five storage cabinets 170. Particularly, each of the storage cabinets 170 has a base 172 at bottom and five clutches 174 above the base 172. The base 172 is operable to support footrests 118 of one to five electric scooters 108. Each of the clutches 174 has a clutch bar 178 that is hinged to an end of the clutch 174. The clutch bar 178 is rotatable between an opening and closed positions of the clutch 174 such that a steering pole 176 of an electric scooter 108 is able to be held inside a clutch 174, or released from the clutch 174 by opening the bar 178. Accordingly, an electric scooter 108 can be securely locked by a storage cabinet 170 of the tenth docking station 168 because the steering pole 176 is locked inside a clutch 174. FIG. 14 shows that many electric scooters 108 are locked by the tenth docking station 168, whilst each of these electric scooters 108 is accessible for retrieving. Particularly, the two rows of cabinets 170 have a lane in-between, which is about 1.5 metres as passageway.

FIG. 15 illustrates an eleventh docking station 180, which includes four stacked storage drawers 184. The four storage drawers 182 are laid on top of a closet, which encloses communication terminals, a power supply unit and a control unit. Each of the storage drawers 182 contains two guiding rails 184 and a hub connector (not shown). Wheels of a moored electric scooter 108 are held between the two rails 184, and the hub connector is connected to the stored electric scooter 108. A front side of the eleventh docking station 180 is open for access, which is also the open sides of the storage drawers 182.

FIG. 16 illustrates a first cluster 186 of the eleventh docking stations 180. The first cluster has four eleventh docking stations 180. Two of the eleventh docking stations 180 have their opening sides facing the same direction, whilst remaining two eleventh docking stations 180 have their opening sides facing the opposite direction. The four eleventh docking stations 180 are closely attached to each other such that they form a unitary block, similar to a four-sided prism.

FIG. 17 illustrates a second cluster 188 of the eleventh docking stations 180. Similar to the first cluster 186 of docking stations, the second cluster 188 comprises several eleventh docking stations 180. Instead of forming the four-sided prism, the second cluster has a cylindrical profile. A cylindrical surface of the second cluster 188 are formed by opening sides of the eleventh docking stations 180. Hence, the second cluster 188 provides an alternative formation of the eleventh cabinets, making the eleventh docking stations 180 versatile.

FIG. 18 illustrates a twelfth docking station 190 that is an elongated and thin panel. The twelfth docking station 190 has a front end and a back end that are at opposite sides of the panel. A top ridge 192 of the twelfth docking station 190 has a chain 194 throughout a length of the panel, and the chain contains sockets for receiving handles of electric scooters 108 respectively. In contrast, the bottom ridge 196 of the twelfth docking station 190 is smooth, providing negligible friction to wheels of electric scooters 108. For storage at the twelfth docking station 190, an electric scooter 108 is pushed near the front end 198, and its handle 202 is engaged by a socket of the chain 194. The electric scooter 108 continues to be pushed forward till being pushed again a previously stored electric scooter 108. Hence, stored electric scooters 108 are packed against each other, being held continuously at the panel. At the back end 200, a rider pulls a handle 202 of the last electric scooter 108 such that the chain rolls till releasing the handle 202. The last electric scooter 108 is thus being taken away from the twelfth docking station 190 for riding.

FIGS. 19 to 23 refers to a thirteenth docking station 204. Particularly, FIG. 19 illustrates the thirteen docking station 204 that has a control unit and a storage unit (i.e. control box) juxtaposed together. The storage unit 208 is an elongated cabinet with a front aperture 210. In contrast, the control unit 206 is completely sealed, having a touchscreen 212 at its front side, being next to the front aperture 210. A red light indicator and a green light indicator are position at opposite sides of the front aperture 210. The red light indicator is powered when detecting malfunction, whilst the green light indicator is turned on for indicating secured storage of an electric scooter 108. These light indicators are also known as signal lights 128.

FIG. 20 illustrates another view of the thirteenth docking station 204. A base plate 214 is shown to support and join the control unit 206 and storage unit 208 together. External dimensions of the thirteen docking station 204 are clearly labelled. The width of the base plate 214 is 0.85 metres. The length of the base plate 214 is 1.1 metres. The width of the storage unit 208 is 0.35 metres.

FIG. 21 illustrates the thirteenth docking station 204 being partially exposed. A top side of the storage unit 208 is exposed such that a docked electric scooter 108, and a charging dock & lock mechanism become visible.

FIG. 22 illustrates internal guiding mechanism of the thirteenth docking station 204, which shows the charging dock and guiding mechanism on the base plate 214. The guiding mechanism has two upper guides 216 and two lower guides 218 four corners of a rectangular prism, being at opposite sides. Each of the guides has cylindrical steel rollers 220 juxtaposed to each other, covering an entire length of the guide 216,218. The cylindrical steel rollers 220 are configured to push against lateral edges of a footrest 118 of the electric scooter 108 such that the docked electric scooter 108 is held firmly between the guides 216,218.

FIG. 23 illustrates the locking & charging mechanism of the thirteenth docking station 204 with the base plate 214 removed revealing the electric scooter 108 as viewed from the bottom. Particularly, a hub connector of the thirteen docking station 204 is depicted by showing a spring locating mechanism 222. The spring locating mechanism 222 has a stationary connector 224 and a mobile connector 226 for coupling together. The stationary connector 224 is locked to the base plate 214 having cables linked to a charger. The mobile connector 226 is detachable from an electric scooter 108, and connectable to the stationary connector 224. Both the stationary connector 224 and the mobile connector 226 have six electrical contacts 228. The stationary connector 224 and the mobile connector 226 are not connected 230. When the mobile connector 226 is pushed towards 234 the stationary connector 224, the electrical contacts 228 are in contact 232.

The electrical contacts 228 of the two connectors meet each other respectively 232 at a storage position of the electric scooter 108. The electrical contacts 228 provide electrical power and signal communication between the thirteen docking station 204 and the stored electric scooter 108. FIG. 24 illustrates a hub connector 236 of the thirteenth docking station 204. The electrical contacts 228 are more visible in FIG. 24. FIG. 24 additionally shows two electric magnets 238 at opposite sides, which are configured to lock a stored electric scooter 108.

FIG. 25 illustrates a flow chart of the docking station 126. The docking station 300 provides a method of operation having a charging mode, a stop charging mode, a release mode and a locking mode.

The method of operation involves defined methods and control using application programming interface (API) in the communication between software components providing a development of a computer programme. There is a plurality of APIs developed to provide the different operations as mentioned and will be discussed as follows.

In the charging mode, the charging API initiates a “charge” signal 302 activating the charging of the electric scooter 304. In the stop charging mode, the charging API initiates “stop charge” signal 306 deactivating the charging of the electric scooter 308.

In the release mode, the lock/release API initiates a “release electric scooter” signal 310 which opens a lock 312 and then sends an acknowledgement to the lock/release API 314. The lock/release API 314 checks whether the lock is engaged 316. If the electric scooter 108 were not locked, a feedback is sent to the lock/release API to activate the lock 310. However, if after three failed attempts to engage the lock, a red indicator light will be on.

In the locking mode, the lock/release API checks that the locking is successful 318. If it were not locked, the lock/release API checks whether the RFID (Radio frequency identification) code of the electric scooter 108 is registered 320. If it were registered, the electric scooter identity code will be sent to the lock/release API and a red indicator light will be on 322. This implies that there is a fault with the registered electric scooter 108 that requires attention and hence the electric scooter identity code is sent to lock/release API. Conversely, if the RFID code were not found 324, it implies that the electric scooter 108 or the vehicle is disallowed from parking and locking at the docking station 126. Hence, there is no action required.

If the lock is successfully locked, the RFID code of the electric scooter 108 will be checked 326. If the RFID code is found, a docking success message and the electric scooter identity code are then sent to the lock/release API 328. A green indicator light will be on to indicate a successful lock. Conversely, if the RFID code is not found, a docking success message is sent to the lock/release API without the electric scooter identity code and a red light is on 330.

FIG. 26 illustrates a basic operation of the docking station 126. In use, a user opens an application 350 on the smart phone. The user locates a nearby docking station 126 with the available electric scooter 352. At the docking station 126, an indicator light reveals the status of the docking station 354. A red indicator light 356 indicates to the user there is no electric scooter available 358 at the docking station 126 and leads to the end of the process 360. A no light indicates that the electric scooter 108 is available and fully charged 362.

The user approaches the available docking station 126 with the electric scooter 108 and uses his smart phone to capture an image of the Quick Response (QR) code which is labelled on the docking station 364. The successful QR scanning 366 provides a disengaging of the lock 368 at the docking station 126 and a “unlock status” is sent to the lock/release API 370. The user then retrieves the electric scooter 372.

At the docking station, the docking station 126 continually queries if the electric scooter 108 is retrieved 374. If after some time, the electric scooter 108 is not retrieved 376, the lock/release API submits a status update and request the lock to be engaged and locked 376 and leads to the end of the process 360.

The user after retrieving the electric scooter 108 switches on the power 378 and begins to ride. During the ride 380, regular status update of the electric scooter 108 is submitted to the API 382. The API is capable of storing, transmitting, receiving, tracking and locating the location of the electric scooter 108 as well as the battery level status of the electric scooter. Upon returning the electric scooter 108 to the docking station 384, the electric scooter will be locked 386. The RFID code is read by the docking station 388 to indicate a successful return 390. The green indicator light will be lit for ten seconds 392. An end status is submitted to the API 394 and then leads to the end of the process 360.

If, however, the RFID code is not received 388, the return of the electric scooter 108 is rendered unsuccessful 396. The red indicator light is lit 398. A status update is submitted to API 400 and then leads to the end of the process 360. After a ten-minute delay, the electric scooter identity code is sent to the API which will perform a location matching 402 and then leads to the end of the process 360.

FIG. 27 illustrates a flow chart of a vibration alarm of the electric scooter 420. In the event that the electric scooter is being tampered, the electric scooter will vibrate 422 prohibiting the user from using the electric scooter 108. The docking station 126 checks whether the electric scooter is locked 424. If the electric scooter 108 is not locked, the vibration is ignored 426. Conversely, if the electric scooter 108 is locked, a message is sent to the API regarding the vibration alarm 428. The API 430 informs the administrator 432 about the vibration and ends the process 434.

FIG. 28 illustrates the external circuits controlled by a 3G module which is WCDMA (Wideband Code Division Multiple Access). WCDMA is an air interface standard found in 3G mobile telecommunication networks.

The docking station 440 uses the WCDMA unit 442 for mobile communication between the RFID (Radio-Frequency Identification) unit 444, the charging control unit 446, the indicator control unit 448 and the lock control unit 450.

The electric scooter 108 uses the WCDMA unit 442 for controlling the motor and retrieving the data 452 as well as retrieving battery data 454.

In some of the embodiments aforementioned, a plurality of lithium-ion (Li-ion) battery is used at the docking stations whilst some of the embodiments use electrical sources from the public utility. However, the latter implementation would require extensive construction works rendering it expensive and the docking station immovable. For the illustrative purpose, the docking station 126 mentioned herein is connected to the public utility providing electrical power to the electric scooter.

Three of the commonly used Li-ion batteries are lithium manganese oxide (LMO), lithium iron phosphate (LFP) and lithium nickel manganese cobalt oxide (NMC). They are considered safer, lower capacity than lithium cobalt oxide (LCO) which is used in mobile devices like phones and laptops. Even though of the lower capacity, they have high specific power and long operational life. Manganese and phosphate-based lithium-ion, as well as nickel-based chemistries are the best performers for delivering bursts of power on demand.

The performance and operating life of the Li-ion batteries are closely related to the quality of the charging pattern. Therefore, an optimal charging pattern is essential for Li-ion batteries to achieve shorter charging time and longer cycle life. The constant current-constant voltage technique is commonly used for charging Li-ion batteries, but it dramatically extends the charging time and also reduces the operational life of the battery.

Li-ion batteries live longer if treated in a gentle manner. High charge voltages, excessive charge rate and extreme load conditions have a negative effect on battery life. The longevity is often a direct result of the environmental stresses applied. To prolong the battery life, the time at which the battery stays at a maximum voltage should be as short as possible. Prolonged high voltage promotes corrosion, especially at elevated temperatures. The charge current of Li-ion should be moderate. The lower charge current reduces the time in which the cell resides at the maximum voltage. A high current charge tends to push the voltage into voltage limit prematurely. The lithium-ion should not be too deeply discharged. Instead, charge it frequently. Lithium-ion does not have memory problems like nickel-cadmium batteries. No deep discharges are needed for conditioning. The lithium-ion is not charged at or below freezing temperature. Although accepting charge, an irreversible plating of metallic lithium will occur that compromises the safety of the pack. The lithium-ion battery lives longer with a slower charge rate; moderate discharge rates also help.

Li-ion does not need to be fully charged as is the case with lead acid, nor is it desirable to do so. In fact, Li-ion is preferred not to be fully charged because a high voltage stresses the battery. Choosing a lower voltage threshold or eliminating the saturation charge altogether, prolongs battery life but this reduces the runtime (i.e. frequently charged).

In particular, the electric scooters 108 are used by commuters regularly during peak working hours. During peak hours, the scooters are released and locked from the docking stations 126 at a higher frequency. For example, some of the returned electric scooters 108 may have a battery level of 50%, the likelihood of these electric scooters 108 being used again is high during peak hours and hence to commence charging for these electric scooters 108 is not necessary. However, during low peak hours and after hours, the option to retain the electric scooters 108 at the docking stations 126 to perform a full charge is realizable. The retention is made possible only if there were other available electric scooters 108 which are fully charged at other docking stations 126.

FIG. 29 illustrates a process flow chart of a charging protocol 468 of the docking station 126.

A charging protocol 468 which extends the Li-ion battery operating life and minimizing service disruption is provided. The electric scooter 108 at the docking station is locked and the charging protocol 468 begins 470. The API checks the time the electric scooter 108 was docked during a peak hour period. The peak hour period herein refers to the time period where users of the electric scooters 108 are travelling to work or off work, usually the time is from 730 am to 930 am and from 5 pm to 730 pm.

If the electric scooter 108 were docked at 8 am i.e. during the peak hour period 472, the API will proceed to check the battery level of the electric scooter 108. If the battery level were less than 50% 474, the charging begins 476 and will charge until the Li-ion battery level reaches 50%. However, if the battery level is more than 50%, there will be no charging 478 and the docking station will then constantly check the time 472.

Conversely, if the electric scooter 108 is not docked during the peak hour period, the API checks whether the battery level is less than 95% 480. If the battery level is less than 95%, charging begins 476. The Li-ion battery of the electric scooter 108 will be charged until the battery level reaches 95%. Once the battery level reaches 95%, the charging stops 478 and the docking station 126 will then constantly check the time 472.

A charging protocol 468 which extends the Li-ion battery operating life and minimizing service disruption is provided that takes in a list of factors like the usage frequency of scooters and the times of the day which the electric scooters 108 were mobilized. Such information stored over a period of time provides a statistical data for determining the charging time or not to charge of electric scooters 108 and provides a basis for prediction of future demand. In developing the charging protocol 468, a machine learning algorithm is used to learn and improve the charging protocol as more data is available. The input data to the charging protocol 468 is the current battery level and the demand prediction (spatio-temporal demand of the sharing system). The charging protocol 468 learns by using operational and laboratory data. The operational data is obtained from trip history and system logs of the electric scooter 108. The operation data is supplied as input to a machine learning algorithm. The laboratory data is obtained from simulation from software simulation and lab experiments of the electric scooter 108. The output from the charging protocol 468 comprising a start/stop charging initialisation, a charging voltage and a charging current.

In the application, unless specified otherwise, the terms “comprising”, “comprise”, and grammatical variants thereof, intended to represent “open” or “inclusive” language such that they include recited elements but also permit inclusion of additional, non-explicitly recited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. The description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

### REFERENCE NUMERALS

100 first docking station
102 shelter
104 first row of holders
106 second row of holders
108 electric scooter(s)
110 floor
112 ceiling
114 pillar
116 solar panels
118 footrest of electric scooter
120 second docking station
122 third docking station
124 kerb or curb
126 fourth docking station
128 light indicators
130 receptacle
132 QR code
134 fifth docking station
136 guiding chute
138 sixth docking station
140 sealed cabinet
142 internal bars
144 soft curtain
146 seventh docking station
148 robotic arm
150 rail
152 front wheel
154 end-effector
156 eighth docking station
158 vertical holders
160 ninth docking station
162 vertical chute
164 ridge
166 lateral side
168 tenth docking station
170 storage cabinet
172 storage cabinet base
174 clutches
176 steering pole
178 clutch bar
180 eleventh docking station
182 storage drawers
184 guiding rail
186 first cluster
188 second cluster
190 twelfth docking station
192 top ridge
194 chain
196 bottom ridge
198 front end
200 back end
202 handle
204 thirteenth docking station
206 control unit
208 storage unit
210 front aperture
212 touch screen
214 base plate
216 upper guide
218 lower guide
220 cylindrical steel rollers
222 spring locating mechanism
224 stationary connector
226 mobile connector
228 electrical contacts
230 stationary and mobile connectors disconnected
232 stationary and mobile connectors connected
234 mobile connector push towards the stationary connector
236 hub connector
238 electric magnets
300 Start of operation of the docking station
302 From API charge
304 Activate charging
306 From API Stop Charging
308 Deactivate charging
310 From API Release Scooter
312 Open Lock
314 Send API Acknowledgement
316 Lock open?
318 Locking successful?
320 RFID Registered?
322 Send scooter ID & docking failed to API. On red light
324 Do nothing
326 RFID Registered?
328 Send docking success & scooter ID to API. On green light
330 Send docking success & NO scooter ID to API. On red light.
350 User Open App
352 User find scooter
354 Indicator status
356 Red light
358 Unavailable
360 Finish
362 No light
364 User scan QR Code
366 Scan successful?
368 Lock release
370 Submit unlock status to API
372 User retrieve scooter
374 User retrieve?
376 Submit status to API and API request locking
378 User switch on scooter power
380 User riding
382 Submit riding data to API
384 User return
386 locked?
388 Received RFID?
390 Return successful
392 Green indicator light up for 10 sec
394 Submit end status to API
396 Return unsuccessful
398 Red indicator light up
400 Submit status to API
402 10 min later send scooter ID to API, API does location matching
420 a vibration alarm of the electric scooter
422 Vibration
424 Locked?
426 Ignore
428 Submit vibration alarm to API
430 API
432 Inform Administrator
434 Finish
440 Docking station
442 WCDMA module
444 RFID unit
446 Charging Control unit
448 Indicator Control unit
450 Lock Control unit
452 Motor Controller Data retrieving
454 Battery Data Retrieving
468 charging protocol
470 electric scooter at docking station
472 peak hour?
474 battery level is less than 50%
476 charging begins
478 no charging
480 battery level is less than 95%

1-30. (canceled)

31. A docking station for motorised vehicles, the docking station comprising:
a connector for releasably fastening a motorised vehicle to the docking station; and
a charging unit for replenishing the motorised vehicle.

32. The docking station of claim 31 further comprising
a base for supporting the charging unit.

33. The docking station of claim 32, wherein
the base is operable to be fastened to a foundation for secure anchoring.

34. The docking station of claim 31 further comprising
a holder for supporting the motorised vehicle.

35. The docking station of claim 34, wherein
the holder comprises a lock for fastening the motorised vehicle to the docking station.

36. The docking station of claim 31, wherein
the connector is configured to facilitate power charging, mechanical locking and electronic transaction.

37. The docking station of claim 31 further comprising
an user interface for user interaction.

38. The docking station of claim 31 further comprising
a guide for stowing the motorised vehicle.

39. The docking station of claim 31 further comprising
a shelter for preventing intrusion of sunlight, rainwater or dust.

40. A docking harbour for keeping multiple motorised vehicles, the docking harbour comprising
a first docking station according to claim 31;
a second docking station according to claim 31; and
a common platform for joining the first docking station and the second docking station together.

41. A method of using a docking station for a motorised vehicle,
connecting a motorised vehicle;
checking the motorised vehicle; and
releasing the motorised vehicle activation.

42. The method of claim 41 further comprising
fastening the motorised vehicle to the docking station.

43. The method of claim 41 further comprising
communicating with the motorised vehicle.

44. The method of any of claim 41 further comprising
contacting a remote computer.

45. The method of claim 41 further comprising
replenishing the motorised vehicle.
